(19) United States
(12) Patent Application Publication
(10) Pub. No.: US 2025/0245861 A1
(43) Pub. Date: Jul. 31, 2025

(54) POINT CLOUD PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Wenjie ZHU, Shenzhen (CN)

(21) Appl. No.: 19/006,033

(22) Filed: Dec. 30, 2024

Related U.S. Application Data
(63) Continuation of application No. PCT/CN2023/107706, filed on Jul. 17, 2023.

(30) Foreign Application Priority Data
Dec. 12, 2022 (CN) 202211610057.4

(51) Int. Cl. G06T 9/00; H04N 19/159; H04N 19/18; H04N 19/70; H04N 19/93

(52) U.S. Cl. CPC G06T 9/001; H04N 19/159; H04N 19/18; H04N 19/70; H04N 19/93

(57) ABSTRACT

A point cloud processing method, performed by a decoding device and includes obtaining code stream data of point cloud data; parsing the code stream data to obtain group information of the point cloud data, the group information indicating an association relationship, related to encoding and decoding, between groups corresponding to the point cloud data; optimizing a group prediction process based on the association relationship between the groups, to obtain attribute information of the point cloud data; and presenting the point cloud data based on the attribute information of the point cloud data.

### CROSS-REFERENCES TO RELATED APPLICATIONS

This application is a continuation application of PCT Patent Application No. PCT/CN2023/107706, filed on Jul. 17, 2023, which claims priority to Chinese Patent Application No. 202211610057.4, filed on Dec. 12, 2022, all of which is incorporated by reference in their entirety.

### FIELD OF THE TECHNOLOGY

The present disclosure relates to the field of computer technologies and, specifically to point cloud processing.

### BACKGROUND OF THE DISCLOSURE

In current technologies, a large number of high-precision point clouds can be obtained with low costs in a short period of time. The point cloud may include multiple points, and each point in the point cloud has geometric information and attribute information. To improve transmission efficiency of point clouds, it usually requires encoding of relevant information of the point cloud before the transmission of the point cloud. Specifically, after encoding point cloud data, an encoding end may transmit, to a decoding end, code stream data obtained through encoding, and the decoding end may decode the code stream data to reconstruct the relevant information of the point cloud. Because of a large amount of point cloud data, it is a significant challenge to improve efficiency of encoding and decoding the point cloud data.

### SUMMARY

One embodiment of the present disclosure provides a point cloud processing method, performed by a decoding device. The method includes obtaining code stream data of point cloud data; parsing the code stream data to obtain group information of the point cloud data, the group information indicating an association relationship, related to encoding and decoding, between groups corresponding to the point cloud data; optimizing a group prediction process based on the association relationship between the groups, to obtain attribute information of the point cloud data; and presenting the point cloud data based on the attribute information of the point cloud data.

Another embodiment of the present disclosure provides a computer device. The computer device includes a memory and one or more processors, the memory containing a computer program that, when being executed, causes the one or more processors to perform: obtaining code stream data of point cloud data; parsing the code stream data to obtain group information of the point cloud data, the group information indicating an association relationship, related to encoding and decoding, between groups corresponding to the point cloud data; optimizing a group prediction process based on the association relationship between the groups, to obtain attribute information of the point cloud data; and presenting the point cloud data based on the attribute information of the point cloud data.

Another embodiment of the present disclosure provides a non-transitory computer-readable storage medium containing a computer program that, when being executed, causes at least one processor to perform: obtaining code stream data of point cloud data; parsing the code stream data to obtain group information of the point cloud data, the group information indicating an association relationship, related to encoding and decoding, between groups corresponding to the point cloud data; optimizing a group prediction process based on the association relationship between the groups, to obtain attribute information of the point cloud data; and presenting the point cloud data based on the attribute information of the point cloud data.

### BRIEF DESCRIPTION OF THE DRAWINGS

FIG. 1a is a schematic diagram of a compression framework according to an embodiment of the present disclosure.

FIG. 1b is a schematic diagram of a relationship between a block in which a current point is located and a neighbor of a parent block of the block according to an embodiment of the present disclosure.

FIG. 1c is a schematic diagram of a binary tree constructed based on a Hilbert order according to an embodiment of the present disclosure.

FIG. 2 is an architectural diagram of a point cloud processing system according to an embodiment of the present disclosure.

FIG. 3 shows a point cloud processing method according to an embodiment of the present disclosure.

FIG. 4 shows another point cloud processing method according to an embodiment of the present disclosure.

FIG. 5 shows still another point cloud processing method according to an embodiment of the present disclosure.

FIG. 6 shows yet another point cloud processing method according to an embodiment of the present disclosure.

FIG. 7 is a schematic structural diagram of a point cloud processing apparatus according to an embodiment of the present disclosure.

FIG. 8 is a schematic structural diagram of another point cloud processing apparatus according to an embodiment of the present disclosure.

FIG. 9 is a schematic structural diagram of a decoding device according to an embodiment of the present disclosure.

FIG. 10 is a schematic structural diagram of an encoding device according to an embodiment of the present disclosure.

### DESCRIPTION OF EMBODIMENTS

Technical solutions in the embodiments of the present disclosure are clearly and completely described in the following with reference to the accompanying drawings in the embodiments of the present disclosure. It is clear that the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

To more clearly understand the technical solutions provided in the embodiments of the present disclosure, key terms in the embodiments of the present disclosure are described herein first.

(1) Point cloud: The point cloud is a discrete set of points that are irregularly distributed in space and represent a spatial structure and surface attributes of a three-dimensional object or scene. Point clouds may be classified into different categories according to different classification standards. For example, the point clouds may be classified into dense point clouds and sparse point clouds based on methods for obtaining the point clouds. For another example, the point clouds may be classified into static point clouds and dynamic point clouds based on timing types of the point clouds.

(2) Point cloud data: Geometric information and attribute information of points in a point cloud constitute the point cloud data. The geometric information may also be referred to as three-dimensional position information. Geometric information of a specific point in the point cloud is spatial coordinates (x, y, z) of the point, and may include coordinate values of the point in coordinate axis directions of a three-dimensional coordinate system, for example, a coordinate value x in an X-axis direction, a coordinate value y in a Y-axis direction, and a coordinate value z in a Z-axis direction. Attribute information of a specific point in the point cloud may include at least one of the following: color information, material information, or laser reflection intensity information (also referred to as reflectivity). Generally, the points in the point cloud have a same number of pieces of attribute information. For example, each point in the point cloud may have two types of attribute information: the color information and the laser reflection intensity information. For another example, each point in the point cloud may have three types of attribute information: the color information, the material information, and the laser reflection intensity information.

(3) Point cloud compression (PCC): The PCC is a process of compressing geometric information and attribute information of each point in a point cloud to obtain a compressed code stream. The PCC may include two main processes: geometric information compression and attribute information compression. At present, mainstream PCC technologies may be classified into geometry-based PCC and projection-based PCC based on different types of point clouds. Geometry-based point cloud compression (G-PCC) in the Moving Picture Expert Group (MPEG) and the point cloud compression standard AVS-PCC in the Audio Video Coding Standard (AVS) are used herein as examples for description.

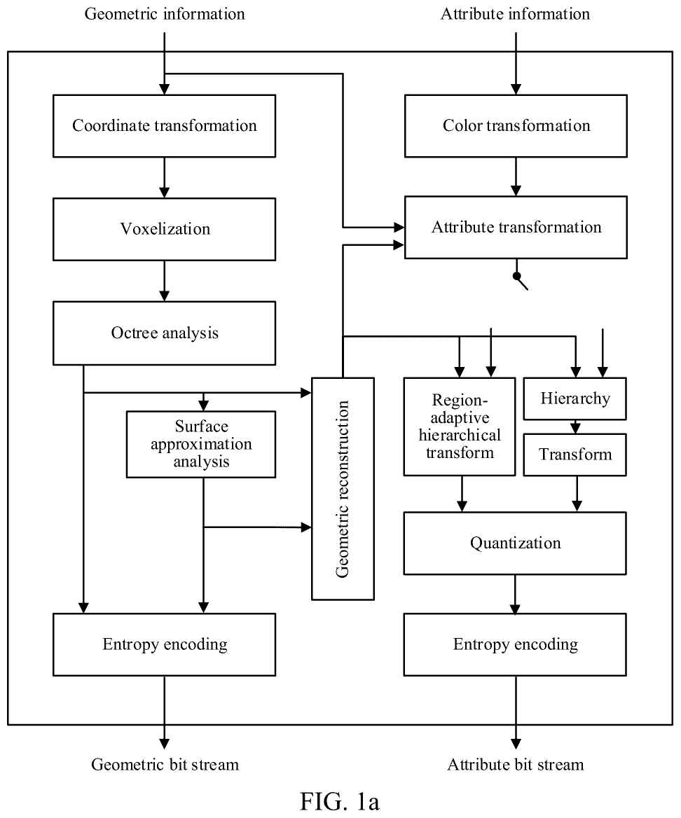

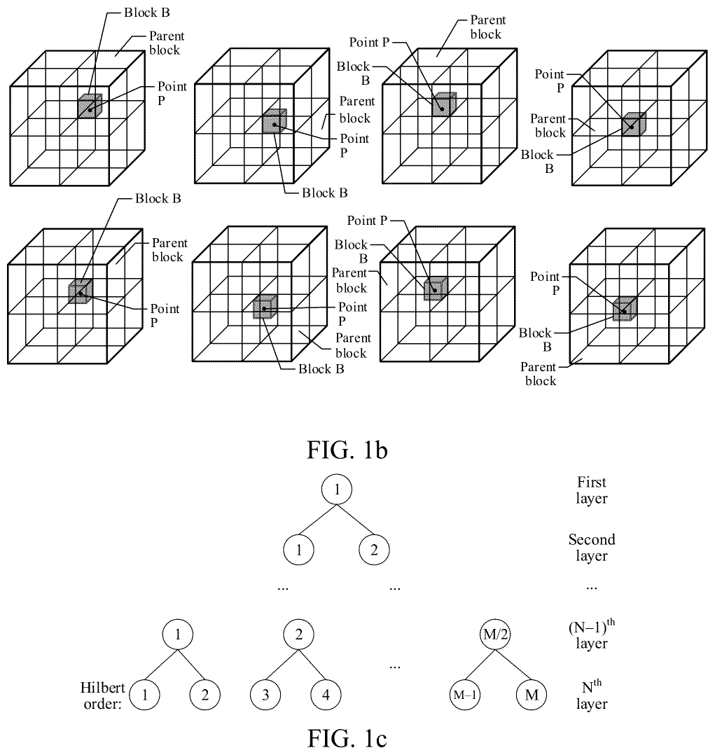

Compression frameworks of the G-PCC and the AVS-PCC are almost the same; and as shown in FIG. 1a, may be divided into a geometric information encoding process and an attribute information encoding process. The geometric information encoding process means encoding geometric information of each point in a point cloud data to obtain a geometric bit stream. The attribute information encoding process means encoding attribute information of each point in the point cloud data to obtain an attribute bit stream. The geometric bit stream and the attribute bit stream together constitute a compressed code stream of the point cloud data.

For main operations and processing of the geometric information encoding process, refer to the following descriptions:

\textcircled{1} Pre-processing: may include coordinate transformation and voxelization. Point cloud data in three-dimensional space is transformed into an integer form through scaling and translation operations, and a smallest geometric position is moved to a coordinate origin.

\textcircled{2} Octree encoding: An octree is a tree data structure. In three-dimensional space division, a preset bounding volume is evenly divided, and each node has eight child nodes. Whether to occupy each child node of the octree is indicated by “1” and “0”, to obtain an occupancy code as a code stream of geometric information of a point cloud. The bounding volume is an algorithm for solving optimal bounding space of a discrete set of points. A basic idea is to approximately replace a complex geometric object with a geometric body (referred to as a bounding volume) with a slightly larger size and a simple feature.

\textcircled{3} Geometry entropy encoding: Statistical compression coding is performed on the occupancy code of the octree, and finally a binary (0 or 1) compressed code stream is outputted. Statistical coding is a lossless coding mode, and can effectively reduce a code rate needed for expressing a same signal. A commonly used statistical coding mode is content adaptive binary arithmetic coding (CABAC).

For main operations and processing of the attribute information encoding process, refer to the following descriptions:

\textcircled{1} Attribute recoloring: for lossy coding, after the geometric information encoding, an encoding end needs to decode and reconstruct the geometric information, that is, to recover the geometric information of each point in the point cloud. Attribute information corresponding to one or more neighboring points in the original point cloud is searched for as attribute information of a reconstructed point.

\textcircled{2} Attribute transformation coding: The attribute information is grouped and transformed and a transformation coefficient is quantized by using an attribute transformation algorithm (for example, DCT or Haar). An attribute reconstruction value is obtained through inverse quantization and inverse transformation. A difference between an original attribute and the attribute reconstruction value is calculated to obtain an attribute residual, and the attribute residual is quantized. A quantized transformation coefficient and a quantized attribute residual are encoded.

\textcircled{3} Attribute quantization: Fineness of quantization is usually determined by using a quantization parameter. In attribute prediction coding, quantized prediction residual information is entropy encoded. In attribute transformation coding and attribute prediction transformation coding, a quantized transformation coefficient is entropy encoded.

\textcircled{4} Attribute entropy coding: Generally, the quantized prediction residual information or transformation coefficient is finally compressed through run-length coding and arithmetic coding. Corresponding information such as a coding mode and a quantization parameter is also encoded by an entropy encoder.

(4) Point cloud decompression: The point cloud decompression is a process of decompressing a compressed code stream obtained through PCC, to reconstruct a point cloud. In detail, the point cloud decompression is a process of reconstructing geometric information and attribute information of each point in the point cloud based on a geometric bit stream and an attribute bit stream in the compressed code stream. After obtaining the compressed code stream, a decoding end first entropy decodes the geometric bit stream to obtain quantized geometric information of each point in the point cloud, and then performs inverse quantization to reconstruct the geometric information of each point in the point cloud. The attribute bit stream is first entropy decoded to obtain quantized prediction residual information or a quantized transformation coefficient of each point in the point cloud. Then, the quantized prediction residual information is inversely quantized to obtain reconstructed residual information, the quantized transformation coefficient is inversely quantized to obtain a reconstructed transformation coefficient, the reconstructed transformation coefficient is inversely transformed to obtain reconstructed residual information, and the attribute information of each point in the point cloud may be reconstructed based on the reconstructed residual information of each point in the point cloud. The reconstructed attribute information of each point in the point cloud is mapped to the reconstructed geometric information one by one to reconstruct the point cloud.

In addition, the present disclosure further relates to the following technologies:

### (1) Attribute Prediction:

### \textcircled{1} Point Cloud Resorting: A Specific Process is as Follows:

obtaining coordinates (x, y, z) of a point cloud, generating a Morton code or a Hilbert code of each point based on a space filling curve, and sorting the codes based on an encoding order (for example, an ascending order) used for encoding the points, to obtain a Morton order or a Hilbert order. Using a Morton code of geometric coordinates as an example, a geometric position of a point in the point cloud is represented by three-dimensional Cartesian coordinates (X, Y, Z). N bits represent each coordinate value, and coordinates (Xk, Yk, Zk) of a k^{th} point may be represented by:

$$\begin{matrix}{X}^{k} = ( {x}_{N - 1}^{k} {x}_{N - 2}^{k} … {x}_{1}^{k} {x}_{0}^{k} ) \\ {Y}^{k} = ( {y}_{N - 1}^{k} {y}_{N - 2}^{k} … {y}_{1}^{k} {y}_{0}^{k} ) \\ {Z}^{k} = ( {z}_{N - 1}^{k} {z}_{N - 2}^{k} … {z}_{1}^{k} {z}_{0}^{k} )\end{matrix}$$

A Morton code corresponding to the k^{th} point may be represented as follows:

$${M}^{k} = ( {x}_{N - 1}^{k} {y}_{N - 1}^{k} {z}_{N - 1}^{k} , {x}_{N - 2}^{k} {y}_{N - 2}^{k} {z}_{N - 2}^{k} , … {x}_{1}^{k} {y}_{1}^{k} {z}_{1}^{k} , {x}_{0}^{k} {y}_{0}^{k} {z}_{0}^{k} )$$

If every three bits are represented by an octal number, where mₙ^{k}=(xₙ^{k}yₙ^{k}zₙ^{k}), n=0, 1, . . . , N−1, the Morton code corresponding to the k^{th} point may be represented by:

$${M}^{k} = ( {m}_{N - 1}^{k} {m}_{N - 2}^{k} … {m}_{1}^{k} {m}_{0}^{k} )$$

### \textcircled{2} Order-Based Neighbor Point Selection: A Specific Process is as Follows:

The order-based neighbor point selection includes a distance-based selection method and a spatial relationship and distance-based selection method. The methods are described below:

### (i) Distance-Based Method: Specific Operations are as Follows:

A Manhattan distance d=|x−xᵢ|+|y−yᵢ|+|z−zᵢ| from each neighbor candidate point (an i^{th} neighbor candidate point is represented by (xᵢ, yᵢ, zᵢ)) among first P neighbor candidate points in the Morton order or Hilbert order to a current to-be-decoded point (x, y, z) is calculated, where P may be determined by using a maxNumOfNeighbours field. After the Manhattan distance from each neighbor candidate point to the current to-be-decoded point (x, y, z) is obtained, k neighbor candidate points with shortest Manhattan distances may be used as neighbors of the current to-be-decoded point. Alternatively, a largest distance value in k points with shortest Manhattan distances is determined, all neighbor candidate points with Manhattan distances less than or equal to the largest distance value are used as neighbors of the current point, and m points with shortest Manhattan distances are finally determined as nearest neighbors of the current to-be-decoded point, where m and k are positive integers, and m≤k.

### (ii) Spatial Relationship and Distance-Based Selection Method: Specific Operations are as Follows:

First, a size of an initial block is determined, to be specific, a number N of initial right-shift bits of a codeword corresponding to each point is determined. On this basis, N+3 is a corresponding parent block range.

Then, the point cloud is traversed in specific order. As shown in FIG. 1b, a nearest neighbor of the current to-be-decoded point (a point P) is search for in decoded points (limited to a range of first k points) within a range including a parent block of a block B to which the point P belongs and neighbor blocks that are coplanar, collinear, and concurrent with the parent block.

If a number (or quantity), of neighbor points of the current to-be-decoded point, determined based on the foregoing method is insufficient, neighbor point selection is performed based on the distance-based method in (i).

### \textcircled{3} Prediction Value Calculation: A Specific Process is as Follows:

An attribute reconstruction value of each neighbor is set to (Âᵢⱼ) j=0, 1 . . . k. In this case, an attribute prediction value Âᵢ of the current point is:

$${i}_{} = \frac{{\sum }_{j = 1}^{k} {w}_{i j} {ij}_{}}{{\sum }_{j = 1}^{k} {w}_{i j}}$$

### (i) Distance-Based Weighting Calculation:

In an implementation, a reciprocal of a Manhattan distance between the current to-be-decoded point and a neighbor point is used as a weight, and a weighted average of attribute reconstruction values of the k neighbor points is finally calculated to obtain an attribute prediction value. Geometric coordinates of the current to-be-decoded point are set to (xᵢ, yᵢ, zᵢ), and geometric coordinates of a j^{th} neighbor point are set to (xᵢⱼ, yᵢⱼ, zᵢⱼ). In this case, a weight wᵢⱼ of the j^{th} neighbor point is:

$${w}_{i j} = \frac{1}{\vert {x}_{i} - {x}_{ij} \vert + \vert {y}_{i} - {y}_{ij} \vert + \vert {z}_{i} - {z}_{ij} \vert}$$

In another implementation, if components in x, y and z directions use different weights, a weight wᵢⱼ of the j^{th} neighbor point is:

$${w}_{i j} = \frac{1}{a \vert {x}_{i} - {x}_{ij} \vert + b \vert {y}_{i} - {y}_{ij} \vert + c \vert {z}_{i} - {z}_{ij} \vert}$$

### (ii) Distance and Another Parameter-Based Weighting Calculation:

A weight of each neighbor point of the current to-be-decoded point is w=1/d, and an optimized weight of a neighbor candidate point whose distance is equal to the largest distance value is wm=(1/d)*dwm, where a value of dwm is a smaller value between Qstep (an attribute quantization step) and a quantity of neighbor candidate points whose distances are equal to the largest distance value.

### (2) Attribute Transformation:

### \textcircled{1} Wavelet Transform Based Attribute Encoding:

### (i) Binary Tree Construction

First, the Hilbert order of the point cloud is resorted, and an N-layer binary tree is constructed based on a one-dimensional arrangement order, where N is a positive integer. A bottom-up construction method is used. Details are as follows:

Assuming that there are M points in a current point cloud, the M points are used as nodes at a lowest layer (set to an N^{th} level) of the binary tree. Two adjacent points are merged in order, to form a parent node of the two nodes (to be specific, points with serial numbers 1 and 2 are merged, points with serial numbers 3 and 4 are merged, and the rest can be deduced by analogy). These parent nodes constitute nodes at an (N−1)^{th} layer, and these nodes are arranged in merging order (that is, a parent node of the nodes with the serial numbers 1 and 2 ranks first, a parent node of the nodes with the serial numbers 3 and 4 ranks second, and the rest can be deduced by analogy). Two adjacent nodes at the (N−1)^{th} layer are merged in order, to form a parent node of the nodes, namely, a node at an (N−2)^{th} layer, and these parent nodes are arranged in merging order. If a number of nodes at an n^{th} layer is odd, the last node directly becomes a node at an (n−1)^{th} layer (n=2, 3, . . . , or N).

Nodes at each layer are merged based on the foregoing method until there is only one node at a level, where the level is a root node (at the first layer) of the tree, and the N-layer binary tree is obtained, as shown in FIG. 1c.

### (ii) Encoding Process

For the N-layer binary tree constructed above, each leaf node of the binary tree includes one point cloud point. An attribute of the point cloud point is defined as a first attribute coefficient of each leaf node.

Then, transformation calculation is performed on each node at different layers in the N-layer binary tree structure. The transformation starts from the (N−1)^{th} layer of the N-layer binary tree and ends at the first layer of the tree.

The transformation calculation is performed on each target node at the n^{th} layer of the binary tree, where n=1, 2, . . . , or N−1. If the target node has two child nodes, and a transformation matrix is T, T may be expressed as:

$$T = \frac{1}{\sqrt{2}} ( \begin{matrix}1 & 1 \\ 1 & - 1\end{matrix} )$$

First attribute coefficients of the two child nodes are transformed, and obtained transformation coefficients are defined as a first attribute coefficient and a second attribute coefficient of the target node. If the target node has one child node, the target node has only a first attribute coefficient and no second attribute coefficient, and the first attribute coefficient of the target node is equal to a first attribute coefficient of the child node of the target node multiplied by \sqrt{2}.

According to the foregoing transformation method, a first transformation coefficient of the root node and a second transformation coefficient of a node at another layer are finally outputted as a transformation coefficient, and quantization coding is performed on the transformation coefficient.

### \textcircled{2} Prediction and Transformation Fused Attribute Encoding:

First, a to-be-encoded point cloud on which color space conversion and recoloring have been performed is resorted in ascending order of Hilbert codes, and then adaptive grouping and corresponding K-element transformation are used. A specific process is as follows:

### (i) Point Cloud Grouping:

The point cloud is grouped in sequence based on an order of a space filling curve, and points whose first L bits of Hilbert codes are the same are grouped together. When a quantity of points in a same group is greater than a preset limit, fine grouping is performed. In addition, adjustment may be performed based on a quantity of grouping points in a preorder group during the grouping.

### (ii) Intra-Group Prediction:

A prediction point selection range falls within preorder P points of the first point in a current group, where P may be determined by using a maxNumOfNeighbours field. The P points are predicted point by point, and a unified prediction value is selected or calculated for each group. For example, a prediction value of the first point in the current group is used as a prediction value of the current group.

(iii) Residual Value Based Transformation:

K_i-element discrete cosine transform (DCT) is performed on an attribute prediction residual value of each group of points, where K_i=2, . . . , or 8, and quantization entropy encoding is performed on a transformation coefficient. When K_i=1, the quantization entropy encoding is directly performed on the attribute residual value without any transformation calculation. The obtained transformation coefficient is quantized.

### (3) Entropy Encoding:

A quantized attribute prediction residual value or transformation coefficient with a symbol is binarized and processed. The entropy encoding may use variable-length encoding, CABAC, run-length coding, or the like. Details are as follows:

### \textcircled{1} Variable-Length Encoding:

Codewords with different lengths represent a residual or coefficient that needs to be encoded. It is necessary to design a code length based on a symbol occurrence probability. Commonly used variable-length encoding includes exp-Golomb coding and arithmetic coding.

### \textcircled{2} CABAC: Mainly Including the Following Operations:

Binarization: The CABAC uses binary arithmetic coding. This means that only two numbers (1 or 0) are encoded. A non-binary numerical symbol, for example, a conversion coefficient or a motion vector, is first binarized or converted into a binary codeword before the arithmetic coding. This process is similar to converting a value into a variable-length codeword. In a specific implementation process, the binary codeword is further encoded by an arithmetic coder before transmission.

Context model selection: A context model is a probability model, and is selected based on statistics of a latest encoded data symbol. The model stores a probability that each ‘bin’ is 1 or 0.

Arithmetic coding: The arithmetic coder encodes each ‘bin’ based on the selected probability model.

Probability updating: The selected context model is updated based on an actual encoding value. For example, if a value of ‘bin’ is 1, a frequency count of 1 increases.

### \textcircled{3} Run-Length Coding:

A quantity of points in statistical data that are consecutive as specific symbols is recorded as a run-length. If a current symbol is 0, a run-length value is increased by 1; If the current symbol is not 0, the run_length value is encoded first, then a prediction residual of the non-zero attribute is encoded, and finally the run-length value is set to 0 to start counting again. A common entropy encoding method, for example, the variable-length coding or the CABAC, may be used for the residual.

Specifically, the run-length coding may be classified into fixed-length coding and variable-length coding. The fixed-length coding means that a quantity of binary digits used for encoding a run-length is fixed. The variable-length encoding means that run-lengths in different ranges are encoded by using different numbers of binary digits, and a used quantity of binary bits needs to be represented by adding a flag bit.

The embodiments of the present disclosure provide a point cloud processing solution based on the related descriptions about the point cloud, the point cloud data, the point cloud compression, the point cloud decompression, the attribute prediction, the attribute transformation, and the entropy encoding. A decoding device obtains code stream data of point cloud data, parses the code stream data to obtain group information of the point cloud data, optimizes a group prediction process based on an association relationship between groups to obtain attribute information of the point cloud data, and presents the point cloud data based on the attribute information of point cloud data. An encoding device obtains to-be-encoded point cloud data, groups points in the point cloud data to obtain group information of the point cloud data, optimizes a group prediction process based on an association relationship between groups to obtain attribute information of the point cloud data, and encodes the attribute information of the point cloud data based on the association relationship between the groups to obtain code stream data of the point cloud data. The group prediction process is optimized based on the association relationship between the groups, so that a prediction result is closer to an actual result, to reduce an amount of data that needs to be encoded or decoded in an encoding or decoding phase, thereby improving efficiency of encoding or decoding the attribute information of a point cloud.

The point cloud processing solution provided in the embodiments of the present disclosure may also be combined with cloud computing, cloud storage, and other technologies in cloud technologies. The cloud computing is a computing mode for distributing computing tasks on a resource pool including a large number of computers, so that various application systems can obtain computing power, storage space, and information services as required. The cloud computing can provide powerful computing support for encoding and decoding phases of point cloud attributes. This can greatly improve efficiency of encoding and decoding the point cloud attributes. The cloud storage is a new concept extended and developed from the concept of cloud computing. A distributed cloud storage system (referred to as a storage system for short below) is a storage system integrating a large number of different types of storage devices (the storage devices are also referred to as storage nodes) in a network through functions such as an application cluster, grid technologies, and distributed file storage systems an via application software or application interfaces to enable the storage devices to work together to provide data storage and service access functions to the outside. The cloud storage can provide powerful storage support for the encoding and decoding stages of the point cloud attributes. This can further improve the efficiency of encoding and decoding the point cloud attributes.

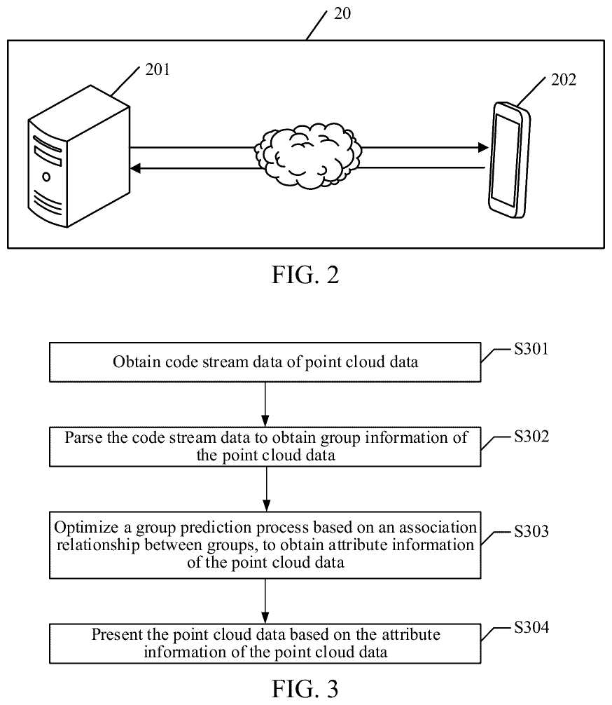

Based on the foregoing descriptions, a point cloud processing system suitable for implementing the point cloud processing solution provided in the embodiments of the present disclosure is described below with reference to FIG. 2. As shown in FIG. 2, the point cloud processing system 20 may include an encoding device 201 and a decoding device 202. The encoding device 201 may be a terminal or a server, the decoding device 202 may be a terminal or a server, and a communication connection may be established between the encoding device 201 and the decoding device 202. The terminal may be a smartphone, a tablet computer, a notebook computer, a desktop computer, a vehicle-mounted terminal, a smart appliance, an uncrewed aerial vehicle, a wearable intelligent device, or the like, but is not limited thereto. The server may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

### (1) For the Encoding Device 201:

The encoding device 201 may obtain point cloud data (namely, geometric information and attribute information of each point in a point cloud), where the point cloud data may be obtained in two manners: scene capture or generation by the device. The scene capture on the point cloud data means collecting a visual scene of the real world by a capture device associated with the encoding device 201, to obtain the point cloud data. The capture device is configured to provide a point cloud data obtaining service for the encoding device 201, and may include but is not limited to any one of the following: a camera device, a sensor device, or a scanning device. The camera device may include an ordinary camera, a stereo camera, a light field camera, or the like. The sensor device may include a laser device, a radar device, or the like. The scanning device may include a three-dimensional laser scanning device or the like. The capture device associated with the encoding device 201 may be a hardware component arranged in the encoding device 201. For example, the capture device is a camera or a sensor of the terminal. The capture device associated with the encoding device may alternatively be a hardware apparatus connected to the encoding device 201, for example, a camera connected to the server. The generating the point cloud data by the device means: The encoding device 201 generates the point cloud data based on a virtual object (for example, a virtual three-dimensional object and a virtual three-dimensional scene that are obtained through three-dimensional modeling).

After generating the point cloud data, the encoding device 201 may encode the point cloud data to obtain code stream data. Specifically, in an encoding process, the encoding device 201 may group points in the point cloud data to obtain group information of the point cloud data, where the group information indicates an association relationship between groups corresponding to the point cloud data; optimize a group prediction process based on the association relationship between the groups to obtain attribute information of the point cloud data; and encode the attribute information of the point cloud data to obtain the code stream data of the point cloud data. After obtaining the code stream data, the encoding device 201 transmits the code stream data to the decoding device 202.

### (2) Decoding Device 202:

After receiving the code stream data transmitted by the encoding device 201, the decoding device 202 may decode the code stream data and present the point cloud data based on a decoding result. Specifically, in a decoding process, the decoding device 202 may parse the code stream data to obtain the group information of the point cloud data, where the group information indicates the association relationship between the groups corresponding to the point cloud data; optimize the group prediction process based on the association relationship between the groups to obtain the attribute information of the point cloud data; and present the point cloud data based on the attribute information of the point cloud data.

In the embodiments of the present disclosure, in an aspect, the code stream data of the point cloud data is obtained; the code stream data is parsed to obtain the group information of the point cloud data; the group prediction process is optimized based on the association relationship between the groups, to obtain the attribute information of the point cloud data; and the point cloud data is presented based on the attribute information of the point cloud data. In another aspect, the to-be-encoded point cloud data is obtained; the points in the point cloud data are grouped to obtain the group information of the point cloud data; the group prediction process is optimized based on the association relationship between the groups to obtain the attribute information of the point cloud data; and the attribute information of the point cloud data is encoded based on the association relationship between the groups to obtain the code stream data of the point cloud data. The group prediction process is optimized based on the association relationship between the groups, so that a prediction result is closer to an actual result, to reduce an amount of data that needs to be encoded or decoded in an encoding or decoding phase, thereby improving efficiency of encoding or decoding the attribute information of a point cloud. The point cloud processing system described in the embodiments of the present disclosure is intended to describe the technical solutions in the embodiments of the present disclosure more clearly, and does not constitute a limitation on the technical solutions provided in the embodiments of the present disclosure. A person of ordinary skill in the art may learn that, with evolution of a system architecture and emergence of new service scenarios, the technical solutions provided in the embodiments of the present disclosure are also applicable to similar technical problems.

Based on the related descriptions of the point cloud processing system, the following describes the point cloud processing solution provided in the embodiments of the present disclosure in detail with reference to the accompanying drawings.

Refer to FIG. 3. FIG. 3 shows a point cloud processing method according to an embodiment of the present disclosure. The point cloud processing method may be performed by a computer device, where the computer device may specifically be the decoding device 202 in the point cloud processing system 20 shown in FIG. 2. As shown in FIG. 3, the point cloud processing method may include S301 to S304:

S301: Obtain code stream data of point cloud data.

A manner in which the computer device obtains the code stream data of the point cloud data may be that the computer device obtains the code stream data from an encoding device in real time, or the computer device downloads the complete code stream data from the encoding device or a server.

S302: Parse the code stream data to obtain group information of the point cloud data.

The group information of the point cloud data indicates an association relationship, related to encoding and decoding, between groups corresponding to the point cloud data, where the association relationship may reflect encoding and decoding related association information between the groups.

The association relationship between the groups may specifically include, but is not limited to: an encoding and decoding sequence relationship of the groups and a relationship between spatial positions of points in the groups.

S303: Optimize a group prediction process based on the association relationship between the groups, to obtain attribute information of the point cloud data.

For an attribute prediction method used by the computer device for points in the point cloud data, refer to the implementation of the attribute prediction above, and details are not described herein again. Attribute information that is of the point cloud data and that corresponds to different encoding modes is different. For example, if encoding is performed in an attribute prediction mode, corresponding attribute information of the point cloud data includes a residual value. If encoding is performed in an attribute transformation mode, corresponding attribute information of the point cloud data includes a transformation coefficient value. If encoding is performed in a mode fusing the attribute prediction and the attribute transformation, corresponding attribute information of the point cloud data includes a residual value and a transformation coefficient value.

In an implementation, the points in the point cloud data are grouped into K groups, and the K groups of points are arranged in decoding order, where K is an integer greater than 1. That the computer device optimizes a group prediction process based on the association relationship between the groups includes optimizing selection of a prediction candidate point in the group prediction process. Specifically, assuming that the computer device is decoding a (P+1)^{th} group in the K groups, a method for optimizing selection of a prediction candidate point in the (P+1)^{th} group includes at least one of the following embodiments:

In an embodiment, in addition to using first N points in the (P+1)^{th} group as prediction candidate points of the (P+1)^{th} group, the computer device may further add P prediction points corresponding to first P groups to the (P+1)^{th} group of prediction candidate points. One group corresponds to one prediction point, an attribute value of a j^{th} prediction point is an attribute reconstruction value of a j^{th} group of points, and coordinates of the j^{th} prediction point are average geometric coordinates of the j^{th} group of points. P is a positive integer less than K, j is a positive integer less than or equal to P, and N is determined by using a maxNumOfNeighbours field. For example, assuming that each group has 100 points, where N=50, and P=10, prediction candidate points in the 11^{th} group may include not only the first 50 points of the 11^{th} group but also 10 prediction points corresponding to the first 10 groups. An attribute value of a prediction point corresponding to the fifth group is an attribute reconstruction value of the fifth group of points, and set coordinates of the prediction point corresponding to the fifth group are average geometric coordinates of the fifth group of points.

In another embodiment, in addition to using first N points in the (P+1)^{th} group as prediction candidate points of the (P+1)^{th} group, the computer device may further add a target prediction point to the (P+1)^{th} group of prediction candidate points. A value of the target prediction point is a weighted average of attribute reconstruction values of first P groups of points. When weights of the attribute reconstruction values of the first P groups of points are all 1, the value of the target prediction point is an average of the attribute reconstruction values of the first P groups of points. Coordinates of the target prediction point are average geometric coordinates of the first P groups of points. For example, assuming that each group has 100 points, where N=50, and P=10, prediction candidate points of the 11^{th} group may include not only the first 50 points in the 11^{th} group but also the target prediction point, an attribute value of the target prediction point is an average or a weighted average of attribute reconstruction values of the first 10 groups, and the coordinates of the target prediction point are average geometric coordinates of the first 10 groups.

In still another embodiment, in addition to using first N points in the (P+1)^{th} group as prediction candidate points of the (P+1)^{th} group, the computer device further replaces a to-be-replaced point in the (P+1)^{th} group of prediction candidate points with a target prediction point. A value of the target prediction point is a weighted average of attribute reconstruction values of first P groups of points. When weights of the attribute reconstruction values of the first P groups of points are all 1, the value of the target prediction point is an average of the attribute reconstruction values of the first P groups of points. Coordinates of the target prediction point are average geometric coordinates of the first P groups of points. The to-be-replaced point may include but is not limited to: the first point in the prediction candidate points, the last point in the prediction candidate points, or the farthest point in the prediction candidate points (a point farthest from average geometric coordinates of the (P+1)^{th} group or a point farthest from the first point in the (P+1)^{th} group).

When a quantity of points in front of the (P+1)^{th} group is less than N (that is, a sum of numbers of points in the first P groups is less than a neighbor quantity threshold (maxNumOfNeighbours)), the computer device may use the P prediction points corresponding to the first P groups or the target prediction point as the prediction candidate point(s) in the (P+1)^{th} group, or may use the P prediction points corresponding to the first P groups or the target prediction point as neighbor point(s) of the (P+1)^{th} group for prediction.

In another implementation, points in the point cloud data are grouped into K groups, and the K groups of points are arranged in decoding order, where K is an integer greater than 1. That the computer device optimizes a group prediction process based on the association relationship between the groups includes optimizing obtaining of a residual value in the group prediction process. Specifically, the computer device obtains a secondary prediction residual value and a reference residual value that correspond to an i^{th} group, where i is a positive integer less than or equal to K. After obtaining the secondary prediction residual value and the reference residual value that correspond to the i^{th} group, the computer device calculates a residual value of each point in the i^{th} group based on the secondary prediction residual value and the reference residual value.

The secondary prediction residual value corresponding to the i^{th} group is obtained by the computer device by parsing the code stream data. The reference residual value corresponding to the i^{th} group may be obtained by the computer device by parsing the code stream data, or may be determined by the computer device based on a residual value of at least one point in first i groups. A specific implementation in which the computer device determines the reference residual value corresponding to the i^{th} group based on the residual value of the at least one point in the first i groups may be any one of the following:

In an embodiment, the computer device may determine a residual value of any point in the first i groups as the reference residual value corresponding to the i^{th} group. For example, the computer device may use a residual value of the third point in an (i−2)^{th} group as the reference residual value corresponding to the i^{th} group. For another example, the computer device may use a residual value of the first point in the i^{th} group as the reference residual value corresponding to the i^{th} group.

In another embodiment, the computer device may calculate the reference residual value corresponding to the i^{th} group based on residual values of at least two points in the first i groups. Specifically, the computer device may determine a weighted average of the residual values of the at least two points in the first i groups (when weights of residual values of all points in the first i groups are 1, the weighted average is an average of the residual values of the at least two points in the first i groups) as the reference residual value corresponding to the i^{th} group. For example, the computer device may use an average of residual values of the first points of first i−1 groups (weights of the residual values of all the points are 1) as the reference residual value corresponding to the it group. For another example, the computer device may use a weighted average of a residual value of the first point in an (i−1)^{th} group and a residual value of the last point in the (i−1)^{th} group as the reference residual value corresponding to the it group. For still another example, the computer device may determine a weighted average of a largest residual value and a smallest residual value in residual values of all points in the i^{th} group as the reference residual value corresponding to the i^{th} group.

In some embodiments, the computer device may alternatively calculate the reference residual value corresponding to the i^{th} group based on a sum of residual values of at least two points in the first i groups, a difference of residual values of at least two points in the first i groups, a logarithmic sum of residual values of at least two points in the first i groups, or the like. Details are not repeated herein.

In still another implementation, points in the point cloud data are grouped into K groups, and the K groups of points are arranged in decoding order, where K is an integer greater than 1. That the computer device optimizes a group prediction process based on the association relationship between the groups includes optimizing obtaining of a transformation coefficient value in the group prediction process. Specifically, the computer device obtains a secondary transformation coefficient value and a reference transformation coefficient value that correspond to an i^{th} group, where i is a positive integer less than or equal to K. After obtaining the secondary transformation coefficient value and the reference transformation coefficient value that correspond to the it group, the computer device calculates a transformation coefficient value of each point in the i^{th} group based on the secondary transformation coefficient value and the reference transformation coefficient value.

The secondary transformation coefficient value corresponding to the i^{th} group is obtained by the computer device by parsing the code stream data. The reference transformation coefficient value corresponding to the i^{th} group may be obtained by the computer device by parsing the code stream data, or may be determined by the computer device based on a transformation coefficient value of at least one point in first i groups. A specific implementation in which the computer device determines the reference transformation coefficient value corresponding to the i^{th} group based on the transformation coefficient value of the at least one point in the first i groups may be any one of the following:

In an embodiment, the computer device may determine a transformation coefficient value of any point in the first i groups as the reference transformation coefficient value corresponding to the i^{th} group. For example, the computer device may use a transformation coefficient value of the third point in an (i−2)^{th} group as the reference transformation coefficient value corresponding to the i^{th} group. For another example, the computer device may use a transformation coefficient value of the first point in the i^{th} group as the reference transformation coefficient value corresponding to the i^{th} group.

In another embodiment, the computer device may calculate the reference transformation coefficient value of the i^{l}i group based on transformation coefficient values of at least two points in the first i groups. Specifically, the computer device may determine a weighted average of the transformation coefficient values of the at least two points in the first i groups as the reference transformation coefficient value corresponding to the i^{th} group (when weights of transformation coefficient values of all points in the first i groups are all 1, the reference transformation coefficient value corresponding to the i^{th} group is an average of the transformation coefficient values of the at least two points in the first i groups). For example, the computer device may use a weighted average of transformation coefficient values of the first points in first i−1 groups as the reference transformation coefficient value corresponding to the i^{th} group. For another example, the computer device may use an average of a transformation coefficient value of the first point in an (i−1)^{th} group and a transformation coefficient value of the last point in the (i−1)^{th} group as the reference transformation coefficient value corresponding to the i^{th} group. For still another example, the computer device may determine a weighted average of a largest transformation coefficient value and a smallest transformation coefficient value in transformation coefficient values of all points in the i^{th} group as the reference transformation coefficient value corresponding to the i^{th} group.

In some embodiments, the computer device may alternatively calculate the reference transformation coefficient value corresponding to the i^{th} group based on a sum of transformation coefficient values of at least two points in the first i groups, a difference of transformation coefficient values of at least two points in the first i groups, a logarithmic sum of transformation coefficient values of at least two points in the first i groups, or the like. Details are not repeated herein.

In another implementation, points in the point cloud data are grouped into K groups, each point in an i^{th} group is associated with R attributes, each attribute corresponds to M transformation coefficients, and the M transformation coefficients corresponding to each attribute include one first transformation coefficient and M−1 second transformation coefficients, where R is a positive integer, K and M are integers greater than 1, and i is a positive integer less than or equal to K. The computer device may perform decoding in a decoding mode corresponding to the encoding mode, where the decoding mode includes but is not limited to the following embodiments:

In an embodiment, (R) first transformation coefficients in the i^{th} group are directly encoded by the encoding device, and intra-group run-length coding is performed by the encoding device on (R*(M−1)) second transformation coefficients in the it group. Correspondingly, the computer device directly decodes the first transformation coefficients in the it group, and performs intra-group run-length decoding on the second transformation coefficients in the it group. Specifically, if a run-length corresponding to the second transformation coefficient is not 0, the computer device performs run-length decoding on the second transformation coefficient. If a run-length corresponding to the second transformation coefficient is 0, the computer device directly decodes the second transformation coefficient.

The attribute information of the point cloud data may include at least one of the following: a residual value of each point or a transformation coefficient value of each point. With reference to this solution, the attribute information of the point cloud data may alternatively be attribute information (such as a secondary prediction residual value, a reference residual value, a secondary transformation coefficient value, a reference transformation coefficient value, a run-length, or a result obtained through shift-and-residue processing) that is of the point cloud data and that is obtained by optimizing the group prediction process based on the association relationship between the groups. For example, the attribute information of the point cloud data includes a first transformation coefficient and a second transformation coefficient of each point. Encoding/decoding modes for the first transformation coefficient and the second transformation coefficient may be the same or different. For example, during the encoding, code stream data corresponding to the first transformation coefficient is obtained by entropy encoding the first transformation coefficient; and code stream data corresponding to the second transformation coefficient is obtained by first performing inter-group run-length coding on the second transformation coefficient (based on the association relationship between the groups) and then performing intra-group run-length coding on a target group (for example, a group including a non-zero second transformation coefficient). In this case, during the decoding, the computer device entropy decodes the code stream data corresponding to the first transformation coefficient in the code stream data to obtain the first transformation coefficient of each point; and performs inter-group run-length decoding on the code stream data corresponding to the second transformation coefficient, and further performs intra-group run-length decoding on an inter-group run-length decoding result to obtain the second transformation coefficient of each point. For another example, during the encoding, code stream data corresponding to the first transformation coefficient is obtained by entropy encoding the first transformation coefficient, and code stream data corresponding to the second transformation coefficient is obtained by performing intra-group run-length coding on the second transformation coefficient. In this case, during the decoding, the computer device entropy decodes the code stream data corresponding to the first transformation coefficient to obtain a shift-and-residue processing result, and then calculates the first transformation coefficient of each point based on the shift-and-residue processing result; and performs intra-group run-length decoding on the code stream data corresponding to the second transformation coefficient to obtain the second transformation coefficient of each point.

In an embodiment, a direct encoding mode includes entropy encoding the attribute information of the point cloud data to obtain S bits of data. Correspondingly, the computer device entropy decodes the S bits of data to obtain the attribute information of each point in the point cloud data. The entropy encoding includes at least one of the following encoding modes: a context model-based encoding mode or a bypass encoding mode. Similarly, the entropy decoding includes at least one of the following decoding modes: a context model-based decoding mode or a bypass decoding mode. The following describes specific implementations of the entropy decoding:

In an implementation, the encoding device encodes the attribute information of each point in the point cloud data in the context model-based encoding mode to obtain the S bits of data. In an embodiment, the encoding device encodes the attribute information of each point in the point cloud data by using a same context model. Correspondingly, the computer device decodes the S bits of data by using a same context model to obtain the attribute information of each point in the point cloud data. In another embodiment, the encoding device encodes the attribute information of each point in the point cloud data by using different context models. Correspondingly, the computer device decodes the S bits of data by using different context models to obtain the attribute information of each point in the point cloud data. Specifically, the S bits of data are divided into first encoded data and second encoded data. During the encoding, the encoding device may indicate, by using at least one preset value, a manner of dividing the S bits of data. Correspondingly, the computer device determines the first encoded data and the second encoded data based on at least one preset value; and decodes the first encoded data by using a first context model (for example, decodes a prefix code of the first encoded data by using a first context model corresponding to a prefix code in exp-Golomb decoding, and decodes a suffix code of the first encoded data by using a first context model corresponding to a suffix code in the exp-Golomb decoding), and decodes the second encoded data by using a second context model, to obtain the attribute information of each point in the point cloud data. The indicating, by using at least one preset value, a manner of dividing the S bits of data is described below by using an example: It is assumed that there is one preset value that is expressed as k (k may be the preset value or an exp-Golomb corresponding order value), where k is greater than or equal to 0 and less than S. In an exp-Golomb encoding mode, the S bits of data include S1 prefix codes and S2 suffix codes, where S=S1+S2. In other encoding modes, the S bits of data may be distinguished by using high bits (such as the first S/2 bits) and low bits (such as the last S/2 bits). The following provides descriptions by using the example in which the S bits of data include the S1 prefix codes and the S2 suffix codes. (1) In the S1 prefix codes, a k^{th} prefix code is obtained by encoding first target data by using a first context model, a (k+1)^{th} prefix code is obtained by encoding second target data by using a second context model, and a remaining prefix code is obtained by encoding third target data by using a third context model. In the S2 suffix codes, a k^{th} suffix code is obtained by encoding fourth target data by using a fourth context model, a (k+1)^{th} suffix code is obtained by encoding fifth target data by using a fifth context model, and a remaining suffix code is obtained by encoding sixth target data by using a sixth context model. Correspondingly, the computer device may decode the S bits of data by using the first context model to the sixth context model. (2) In the S1 prefix codes, a k^{th} prefix code is obtained by encoding first target data by using a first context model, a (k+1)^{th} prefix code is obtained by encoding second target data by using a second context model, a remaining prefix code is obtained by encoding third target data by using a third context model, and the S2 suffix codes are obtained by encoding fourth target data to sixth target data by using a fourth context model. Correspondingly, the computer device may decode the S bits of data by using the first context model to the fourth context model. (3) The S1 prefix codes are obtained by encoding first target data to third target data by using a first context model. In the S2 suffix codes, a k^{th} suffix code is obtained by encoding fourth target data by using a fourth context model, a (k+1)^{th} suffix code is obtained by encoding fifth target data by using a fifth context model, and a remaining suffix code is obtained by encoding sixth target data by using a sixth context model. Correspondingly, the computer device may decode the S bits by using the first context model and the fourth context model to the sixth context model. (4) In the S1 prefix codes, a k^{th} prefix code is obtained by encoding first target data by using a first context model, a (k+1)^{th} prefix code is obtained by encoding second target data by using a second context model, and a remaining prefix code is obtained by encoding third target data by using a third context model. In the S2 suffix codes, a k^{th} suffix code is obtained by encoding fourth target data by using a fourth context model, a (k−1)^{th} suffix code is obtained by encoding fifth target data by using a fifth context model, and a remaining suffix code is obtained by encoding sixth target data by using a sixth context model. Correspondingly, the computer device may decode the S bits of data by using the first context model to the sixth context model. For details, refer to Table 1:

TABLE 1

| | | |
|---|---|---|
| Prefix code | s1 = k | First context model |
| | s1 = k + m | Second context model |
| | s1 is another bit | Third context model |
| Suffix code | s2 = k | Fourth context model |
| | s2 = k − n | Fifth context model |
| | s2 is another bit | Sixth context model |

k may be the preset value or the exp-Golomb corresponding order value, m and n are both greater than 1, and m and n may be the same or different. A prefix code bit is s1, and a suffix code bit is s2. The S bits of data include the S1 prefix codes and the S2 suffix codes, where S=S1+S2.

For another example, it is assumed that there are two preset values that are expressed as k1 and k2. In the S1 prefix codes, a k^{th} prefix code is obtained by encoding first target data by using a first context model, and a remaining prefix code is obtained by encoding second target data by using a second context model. In the S2 suffix codes, a k2^{th} suffix code is obtained by encoding third target data by using a third context model, and a remaining suffix code is obtained by encoding fourth target data by using a fourth context model.

For still another example, in the S1 prefix codes, prefix codes (such as the first prefix code to an m1^{th} prefix code, where m1 is a positive integer less than S1) belonging to a first set are obtained by encoding first target data by using a first context model, prefix codes (such as an (m1+1)^{th} prefix code to an m2^{th} prefix code, where m2 is a positive integer greater than m1 but less than S1) belonging to a second set are obtained by encoding second target data by using a second context model, and a remaining prefix code is obtained by encoding third target data by using a third context model. In the S2 suffix codes, suffix codes (such as the first suffix code to an (m3+1)^{th} suffix code, where m3 is a positive integer less than S2) belonging to a third set are obtained by encoding fourth target data by using a fourth context model, suffix codes (such as the m3^{th} suffix code to an m4^{th} suffix code, where m4 is a positive integer greater than m3 but less than S2) belonging to a fourth set are obtained by encoding fifth target data by using a fifth context model, and a remaining suffix code is obtained by encoding sixth target data by using a sixth context model. Correspondingly, the computer device may decode the S bits of data by using the first context model to the sixth context model. For details, refer to Table 2:

TABLE 2

| | | |
|---|---|---|
| Prefix code | 1 to s1 bits | First context model |
| | s1 + 1 to s2 bits | Second context model |
| | Another bit | Third context model |
| Suffix code | 1 to s3 bits | Fourth context model |
| | s3 + 1 to s4 bits | Fifth context model |
| | Another bit | Sixth context model |

s1 to s4 may be preset values; or s1 may be the exp-Golomb corresponding order value, and s3 may be obtained by using a length of the prefix code. Any one of the foregoing context model-based encoding and decoding modes may alternatively be replaced with the bypass encoding and decoding mode. Details are not described herein.

In this case, bits of data whose ranks are less than k in the S bits of data are grouped into the first encoded data, and bits of data whose ranks are greater than or equal to k in the S bits of data are grouped into the second encoded data. Alternatively, bits of data whose values are less than k in the S bits of data are grouped into the first encoded data, and bits of data whose values are greater than or equal to k in the S bits of data are grouped into the second encoded data. Assuming that there are two preset values that are expressed as k1 and k2 (k1 and k2 may be the preset values or exp-Golomb corresponding order values), where k1 and k2 are greater than or equal to 0. In this case, bits of data whose ranks are less than k1 and values are less than k2 in the S bits of data are grouped into the first encoded data, and a remaining bit of data is grouped into the second encoded data.

In another implementation, the encoding device encodes the attribute information of each point in the point cloud data in the bypass encoding mode to obtain the S bits of data. Correspondingly, the computer device decodes the S bits of data in the bypass decoding mode to obtain the attribute information of each point in the point cloud data.

In an implementation, the attribute information of the point cloud data includes a first attribute information set and a second attribute information set. During the encoding, the encoding device may encode the first attribute information set and the second attribute information set in any two of the first context model-based encoding mode, the second context model-based encoding mode, and the bypass encoding mode to obtain the first encoded data and the second encoded data. Correspondingly, the computer device may decode the first encoded data and the second encoded data in corresponding decoding modes to obtain the first attribute information set and the second attribute information set. For example, the encoding device encodes attribute information in the first attribute information set in the first context model-based encoding mode to obtain the first encoded data, and encodes attribute information in the second attribute information set in the bypass encoding mode to obtain the second encoded data. In this case, the computer device decodes the first encoded data in a first context model-based decoding mode to obtain the first attribute information set, and decodes the second encoded data in the bypass decoding mode to obtain the second attribute information set.

In an embodiment, the encoding device first binarizes (for example, performs exp-Golomb encoding on) the attribute information of each point to obtain a binarization result, and then entropy encodes the binarization result to obtain the S bits of data. Correspondingly, the computer device entropy decodes the S bits of data to obtain the binarization result, and then restores the attribute information of each point in the point cloud data based on the binarization result. For example, assuming that the computer device entropy decodes the S bits of data to obtain a binarization result of a residual value of a point A: 011, the computer device restores the residual value of the point A as 3 based on the binarization result of the residual value of the point A.

In another embodiment, the encoding device first performs shift-and-residue processing on the attribute information of each point to obtain a shift-and-residue processing result, then binarizes the shift-and-residue processing result to obtain a binarization result, and entropy encodes the binarization result to obtain the S bits of data. Correspondingly, the computer device entropy decodes the S bits of data to obtain the binarization result, and then restores the shift-and-residue processing result based on the binarization result. The shift-and-residue processing result includes a quotient and a remainder of the attribute information of each point. After obtaining the shift-and-residue processing result, the computer device calculates the attribute information of each point in the point cloud data based on the quotient and the remainder of the attribute information of each point. The entropy encoding includes at least one of the following encoding modes: the context model-based encoding mode or the bypass encoding mode. Similarly, the entropy decoding includes at least one of the following decoding modes: the context model-based decoding mode or the bypass decoding mode. For example, assuming that a quotient of the residual value of the point A in the binarization result is: 010, and a remainder is: 001, after the binarization result is restored, the shift-and-residue processing result of the residual value of the point A is: a quotient is 2, and a remainder is 1. The residual value of the point A is calculated to be 5 by using the shift-and-residue processing result of the residual value of the point A.

In another implementation, the encoding device performs run-length coding on the attribute information of each point to obtain the S bits of data, where S is a positive integer. The S bits of data indicate a run-length coding parameter, and the run-length coding parameter includes: a run-length and encoding information that is not a preset value (for example, 0) and that is in the attribute information of each point. An encoding mode for the attribute information that is not the preset value may include but is not limited to: a residual value-based encoding mode, a transformation coefficient-based encoding mode, and entropy encoding. Correspondingly, the computer device performs run-length decoding on the S bits of data to obtain the attribute information of each point.

In an embodiment, the encoding device may alternatively perform shift-and-residue processing on a run-length coding result to obtain the S bits of data, where S is a positive integer. Correspondingly, during the decoding, the computer device first calculates the run-length coding parameter by using the shift-and-residue processing result, and then determines the attribute information of each point based on the run-length coding parameter.

In another embodiment, the encoding device may alternatively binarize a run-length coding result to obtain the S bits of data, where S is a positive integer. Correspondingly, during the decoding, the computer device first restores the run-length coding parameter by using a binarization result, and then determines the attribute information of each point based on the run-length coding parameter.

In still another embodiment, the encoding device may alternatively perform shift-and-residue processing on a run-length coding result to obtain a shift-and-residue result, and then binarize the shift-and-residue result to obtain the S bits of data, where S is a positive integer. Correspondingly, during the decoding, the computer device first restores the shift-and-residue result by using a binarization result, then calculates the run-length coding parameter by using the shift-and-residue processing result, and determines the attribute information of each point based on the run-length coding parameter.

In another embodiment, inter-group run-length coding is performed by the encoding device on the (R*M) transformation coefficients in the i^{th} group. Correspondingly, the computer device performs inter-group run-length decoding on the transformation coefficients in the i^{th} group if a group run-length corresponding to the i^{th} group is not 0. The computer device decodes (for example, directly decodes or performs intra-group run-length decoding on) the transformation coefficients in the i^{th} group one by one if a group run-length corresponding to the i^{th} group is 0.

In still another embodiment, the (R) first transformation coefficients in the i^{th} group are directly encoded by the encoding device, and inter-group run-length coding is performed by the encoding device on the (R*(M−1)) second transformation coefficients in the i^{th} group.

Correspondingly, the computer device directly decodes the first transformation coefficients in the it group; and performs inter-group run-length decoding on the second transformation coefficients in the i^{th} group if a group run-length corresponding to the i^{th} group is not 0; or decodes (for example, directly decodes or performs intra-group run-length decoding on) the second transformation coefficients in the i^{th} group one by one if a group run-length corresponding to the i^{th} group is 0.

In yet another embodiment, shift-and-residue encoding is performed by the encoding device on the (R) first transformation coefficients in the i^{th} group, and the (R*(M−1)) second transformation coefficients in the i^{th} group are directly encoded by the encoding device. Correspondingly, the computer device performs shift-and-residue decoding on the first transformation coefficients in the i^{th} group, and directly decodes the second transformation coefficients in the i^{th} group. A specific implementation of performing shift-and-residue encoding on target to-be-encoded information is: performing shift processing on the target to-be-encoded information to obtain shifted data of the target to-be-encoded information, where the shifted data may specifically include a to-be-encoded shifted quotient and a to-be-encoded shifted remainder of the target to-be-encoded information; and encoding, by the computer device, the shifted data of the target to-be-encoded information after obtaining the shifted data of the target to-be-encoded information. Using an example in which the target to-be-encoded information is a residual value of a current point in a point cloud in a k^{th} direction, Table 3 enumerates an example of performing shift and-residue encoding on the residual value of the current point in the k^{th} direction.

TABLE 3

```
geometry_predtree_node(nodeIdx) {
  for( k = 0; k < 3; k++ ) {
    ptn_residual_eq0_flag[k]
    if( !ptn_residual_abs_eq0_flag[k] ) {
      ptn_residual_abs_remaining[k]
      ptn_residual_abs_half_eq0_flag[k]
      if( !ptn_residual_abs_half_eq0_flag[k] ) {
        ptn_residual_abs_numbits[k]
        for(j=0; j< ptn_residual_abs_numbits[k];j++){
          ptn_residual_abs_value_per[k][j]
      }
    }
  }
}
```

nodeIdx in Table 3 indicates the current point in the point cloud. k indicates the k^{th} direction of the current point. ptn_residual_abs_eq0_flag (a to-be-encoded information flag field) indicates whether the target to-be-encoded information is 0. When the field is set to 1, it indicates that the target to-be-encoded information is 0; or when the field is set to 0, it indicates that the target to-be-encoded information is not 0 (and is greater than 0). ptn_residual_abs_remaining ptn indicates a to-be-encoded shifted remainder obtained by performing shift processing on the target to-be-encoded information. ptn_residual_abs_half_eq0_flag (shifted quotient flag field) indicates whether a to-be-encoded shifted quotient obtained by performing shift processing on the target to-be-encoded information is 0. When the field is set to 1, it indicates that the to-be-encoded shifted quotient is 0; or when the field is set to 0, it indicates that the to-be-encoded shifted quotient is not 0 (and is greater than 0). ptn_residual_abs_numbits (number-of-occupied-bits field) indicates a number of bits occupied by the current to-be-encoded value. ptn_numbits_remaining (occupancy remainder field) indicates a shifted occupancy remainder obtained by performing shift processing on the number of occupied bits. ptn_residual_abs_value_per (bit value field) indicates a value of each bit in the number of occupied bits. A corresponding decoding process is: (1) parsing whether ptn_residual_abs_eq0_flag[k] is 0; and if ptn_residual_abs_eq0_flag[k] is 0, continuing to perform parsing; or if ptn_residual_abs_eq0_flag[k] is not 0, determining that the residual value of the current point in the k^{th} direction is A[k]=0; (2) if ptn_residual_abs_eq0_flag[k] is 0, parsing ptn_residual_abs_remaining[k] to obtain the to-be-encoded shifted remainder A2[k] of the residual value of the current point in the k^{th} direction; (3) parsing whether ptn_residual_abs_half_eq0_flag[k] is 0; and if ptn_residual_abs_half_eq0_flag[k] is 0, continuing to perform parsing; or if ptn_residual_abs_half_eq0_flag[k] is not 0, determining that the to-be-encoded shifted quotient of the residual value of the current point in the k^{th} direction is A1[k]=0; (4) if ptn_residual_abs_half_eq0_flag[k] is 0, parsing the to-be-encoded shifted quotient A1[k] of the residual value of the current point in the k^{th} direction in a number-of-bits encoding mode, in other words, parsing ptn_residual_abs_numbits[k] and ptn_residual_abs_value_per[k][j] to obtain the to-be-encoded shifted quotient A1[k] of the residual value of the current point in the k^{th} direction; and (5) reconstructing the residual value A[k] of the current point in the k^{th} direction by using the to-be-encoded shifted quotient A1[k] and the to-be-encoded shifted remainder A2[k]: A[k]=A1[k]<<s1+A2[k].

In another implementation, points in the point cloud data are grouped into K groups, an i^{th} group includes M points, each point is associated with R attributes, and each attribute corresponds to M transformation coefficients, where R is a positive integer, K and M are integers greater than 1, and i is a positive integer less than or equal to K. The encoding device performs shift-and-residue encoding on a non-zero transformation coefficient in the i^{th} group if M is less than a third number threshold. Correspondingly, the computer device performs shift-and-residue decoding on the non-zero transformation coefficient in the it group. The encoding device directly encodes a non-zero transformation coefficient in the i^{th} group if M is greater than or equal to a third number threshold. Correspondingly, the computer device directly decodes the non-zero transformation coefficient in the i^{th} group.

In still another implementation, points in the point cloud data are grouped into K groups, an attribute of a j^{th} point in an i^{th} group includes Q component attributes, and each component attribute corresponds to one transformation coefficient, where Q is a positive integer, K is an integer greater than 1, i is a positive integer less than or equal to K, and j is a positive integer. The encoding device calculates a sum of absolute values of at least two component attributes in the Q component attributes to obtain a component attribute merging value. The encoding device directly encodes a non-zero transformation coefficient in the transformation coefficients corresponding to the Q component attributes if the component attribute merging value is less than a numerical threshold. Correspondingly, the computer device directly decodes the non-zero transformation coefficient in the transformation coefficients corresponding to the Q component attributes. The encoding device performs shift-and-residue encoding on a non-zero transformation coefficient in the transformation coefficients corresponding to the Q component attributes if the component attribute merging value is greater than or equal to a numerical threshold. Correspondingly, the computer device performs shift-and-residue decoding on the non-zero transformation coefficient in the transformation coefficients corresponding to the Q component attributes.

S304: Present the point cloud data based on the attribute information of the point cloud data.

In an implementation, the computer device renders reconstructed points based on the attribute information of the point cloud data, to obtain and present point cloud frames corresponding to the point cloud data.

In this embodiment of the present disclosure, the code stream data of the point cloud data is obtained; the code stream data is parsed to obtain the group information of the point cloud data; the group prediction process is optimized based on the association relationship between the groups, to obtain the attribute information of the point cloud data; and the point cloud data is presented based on the attribute information of the point cloud data. It can be learned that the group prediction process is optimized based on the association relationship between the groups, so that a prediction result is closer to an actual result, to reduce an amount of data that needs to be decoded in a decoding phase, thereby improving efficiency of decoding the attribute information of the point cloud.

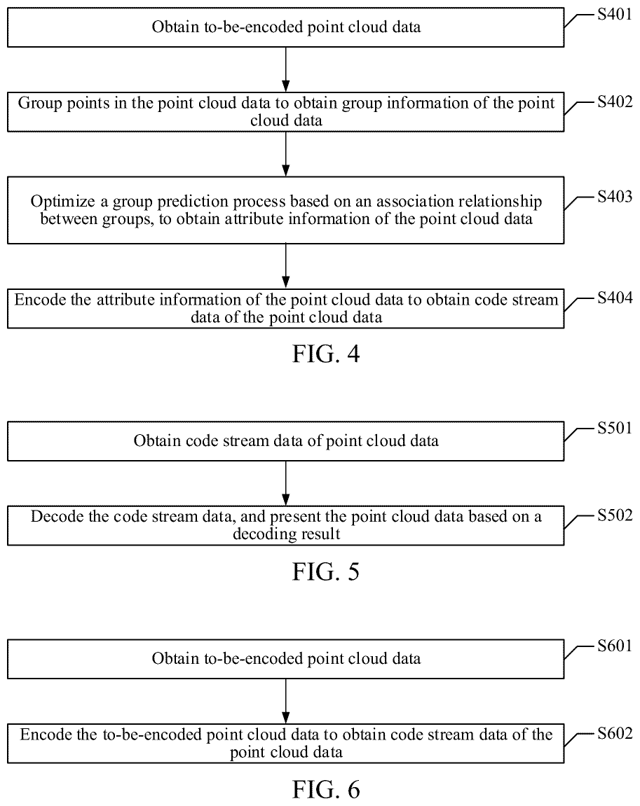

Refer to FIG. 4. FIG. 4 shows another point cloud processing method according to an embodiment of the present disclosure. The point cloud processing method may be performed by a computer device, where the computer device may specifically be the encoding device 201 in the point cloud processing system 20 shown in FIG. 2. As shown in FIG. 4, the point cloud processing method may include S401 to S404:

S401: Obtain to-be-encoded point cloud data.

From the perspective of an obtaining manner, there may be two manners of obtaining the to-be-encoded point cloud data: obtaining the to-be-encoded point cloud data by collecting sound-visual scenes of the real world by a capture device and generating the to-be-encoded point cloud data by the computer. In an implementation, the capture device may be a hardware component disposed in a content manufacturing device. For example, the capture device is a microphone, a camera, or a sensor of a terminal. In another implementation, the capture device may be a hardware apparatus connected to a content manufacturing device, for example, a camera connected to a server, and is configured to provide, for the content manufacturing device, a service of obtaining media content of the point cloud data. The capture device may include but is not limited to: an audio device, a camera device, and a sensor device. The audio device may include an audio sensor, a microphone, or the like. The camera device may include an ordinary camera, a stereo camera, a light field camera, or the like. The sensor device may include a laser device, a radar device, or the like. There may be multiple capture devices, and these capture devices are deployed in some specific positions in real space to simultaneously capture audio content and video content at different angles in the space. The captured audio content and video content are synchronized in terms of time and space.

S402: Group points in the point cloud data to obtain group information of the point cloud data.

In an implementation, the computer device groups the points in the point cloud data based on a space filling curve to obtain the group information of the point cloud data. A coordinate arrangement order of the space filling curve is determined based on a three-dimensional frame to which the point cloud data belongs. For example, assuming that coordinates of the space filling curve are arranged in ascending order of side lengths of the three-dimensional frame to which the point cloud data belongs, a side length, of the three-dimensional frame to which the point cloud data belongs, in a direction corresponding to an x axis is 4 m, a side length of the three-dimensional frame in a direction corresponding to a y axis is 3 m, and a side length of the three-dimensional frame in a direction corresponding to a z axis is 5 m, the coordinate arrangement order of the space filling curve is (y, x, z). For another example, assuming that coordinates of the space filling curve are arranged in descending order of side lengths of the three-dimensional frame to which the point cloud data belongs, a side length, of the three-dimensional frame to which the point cloud data belongs, in a direction corresponding to an x axis is 4 m, a side length of the three-dimensional frame in a direction corresponding to a y axis is 3 m, and a side length of the three-dimensional frame in a direction corresponding to a z axis is 5 m, the coordinate arrangement order of the space filling curve is (z, x, y).

In a point cloud grouping process, the computer device may further control a number of points in each group by using a first number threshold and a second number threshold, where the first number threshold is greater than the second number threshold, and a specific number control method may be any one of the following embodiments:

In an embodiment, it is assumed that the points in the point cloud data have been grouped into K groups, where K is a positive integer. If a quantity of points in an it group is greater than the first number threshold, points that are in the i^{th} group and whose coordinate values in a target direction belong to a numerical interval are grouped into one group, and points other than the points whose coordinate values in the target direction belong to the numerical range in the i^{th} group are grouped into another group. For example, assuming that the target direction is the direction corresponding to the y axis, and the numerical interval is [40, 41], the computer device groups, into one group, points that are in the i^{th} group and whose values in the direction corresponding to the y axis fall within [40, 41], and groups, into another group, points other than the points whose values in the direction corresponding to the y axis fall within [40, 41] in the it group. For another example, assuming that the target direction is the direction corresponding to the z axis, and the numerical interval is [5, 5], the computer device groups, into one group, points that are in the i^{th} group and whose values in the direction corresponding to the z axis fall within [5, 5], and groups, into another group, points other than the points whose values in the direction corresponding to the z axis are 5 in the it group.

The target direction is a direction corresponding to a side with a shortest side length in a three-dimensional frame to which the points in the i^{th} group belong, where i is a positive integer less than or equal to K. For example, assuming that a numerical range of the points in the i^{th} group in the direction corresponding to the x axis is [20, 30], a numerical range in the direction corresponding to the y axis is [5, 40], and a numerical range in the direction corresponding to the z axis is [45, 50], a side length, of the three-dimensional frame to which the points in the i^{th} group belong, in the direction corresponding to the x axis is 10, a side length of the three-dimensional frame in the direction corresponding to the y axis is 30, and a side length of the three-dimensional frame in the direction corresponding to the z axis is 5. In this case, the target direction is the direction corresponding to the z axis.

The points in the point cloud data are grouped into K+1 groups in the foregoing case. If a number of points other than the points whose coordinate values in the target direction belong to the numerical interval in the i^{th} group is still greater than the first number threshold, the computer device may repeat the implementation in the foregoing embodiment until numbers of points in all groups obtained through further grouping are less than the first number threshold.

In another embodiment, it is assumed that the points in the point cloud data have been grouped into K groups, and the K groups of points are arranged in encoding order, where K is a positive integer. An i^{th} group and an adjacent group of the i^{th} group are merged if a quantity of points in the i^{th} group is less than the second number threshold N, to obtain a merged group, where the adjacent group of the i^{th} group may specifically be an (i−1)^{th} group or an (i+1)^{th} group, where N is a positive integer. The computer device may divide the merged group evenly after obtaining the merged group, to obtain an updated i^{th} group and an updated adjacent group of the i^{th} group. Alternatively, N points in the merged group may be grouped into an i^{th} group, and points other than the N points in the merged group are grouped into an adjacent group of the i^{th} group. For example, assuming that i=4, N=50, a number of points in the fourth group is 40, a number of points in the third group is 80, and a number of points in the fifth group is 90, the computer device may merge the points in the fourth group and the points in the third group to obtain a merged group, or may merge the points in the fourth group and the points in the fifth group to obtain a merged group. Using the example in which the points in the fourth group and the points in the third group are merged to obtain the merged group, a number of points in the merged group is 120, and the computer device may use the first 50 points in the 120 points as an updated third group, and use the last 70 points as an updated fourth group. Alternatively, the first 60 points in the 120 points may be used as an updated third group, and the last 60 points may be used as an updated fourth group (that is, the points are evenly divided). Alternatively, the first 70 points in the 120 points may be used as an updated third group, and the last 50 points may be used as an updated fourth group.

If a number of points in the merged group is less than 2N, the computer device may continue to merge the merged group and an adjacent group of the merged group until a number of points in a merged group is greater than or equal to (S+1)*N after S times of merging, where S is a positive integer. For example, assuming that i=4, N=50, a number of points in the fourth group is 30, a number of points in the fifth group is 60, and a number of points in the sixth group is 90, the computer device may merge the points in the fourth group and the points in the fifth group for the first time to obtain a number of points in a merged group 1: 90<2N, and the computer device continues to merge the points in the merged group 1 and the points in the sixth group for the second time to obtain a number of points in a merged group 2: 180>3N. Further, the computer device may divide the merged group 2 evenly after obtaining the merged group 2, to obtain updated fourth to sixth groups (a quantity/number of points in each of the updated fourth to sixth groups is 60). The computer device may alternatively use the first 50 points in the merged group 2 as an updated fourth group, use the 51^{st} to 100^{th} points in the merged group 2 as an updated fifth group, and use the last 80 points in the merged group 2 as an updated sixth group.

In still another embodiment, it is assumed that the points in the point cloud data have been grouped into K groups, and the K groups of points are arranged in encoding order, where K is a positive integer. A number of points in an i^{th} group is increased or decreased by 1 if the number of points in the i^{th} group is odd, where i is a positive integer less than or equal to K. The increase by 1 may be understood as: selecting a point (for example, the first point or the last point) from an adjacent group (for example, an (i−1)^{th} group or an (i+1)^{th} group) of the i^{th} group, and adding the point to the i^{th} group. Similarly, the decrease by 1 may be understood as: selecting a point (for example, the first point or the last point) from the it group, and adding the point to an adjacent group (for example, an (i−1)^{th} group or an (i+1)^{th} group) of the it group. If the i^{th} group is the last group in the K groups (in other words, i=K), and numbers of points in first K−1 groups are all even, the number of points in the i^{th} group remains unchanged.

S403: Optimize a group prediction process based on an association relationship between groups, to obtain attribute information of the point cloud data.

For an attribute prediction method used by the computer device for the points in the point cloud data, refer to the implementation of the attribute prediction above, and details are not described herein again. Attribute information that is of the point cloud data and that corresponds to different encoding modes is different. For example, if encoding is performed in an attribute prediction mode, corresponding attribute information of the point cloud data includes a residual value. If encoding is performed in an attribute transformation mode, corresponding attribute information of the point cloud data includes a transformation coefficient value. If encoding is performed in a mode fusing the attribute prediction and the attribute transformation, corresponding attribute information of the point cloud data includes a residual value and a transformation coefficient value.

In an implementation, the points in the point cloud data are grouped into K groups, and the K groups of points are arranged in encoding order, where K is an integer greater than 1. That the computer device optimizes a group prediction process based on an association relationship between groups includes optimizing selection of a prediction candidate point in the group prediction process. Specifically, the computer device is decoding a (P+1)^{th} group in the K groups, and a method for optimizing selection of a prediction candidate point in the (P+1)^{th} group includes at least one of the following embodiments:

In an embodiment, in addition to using first N points in the (P+1)^{th} group as prediction candidate points of the (P+1)^{th} group, the computer device may further add P prediction points corresponding to first P groups to the (P+1)^{th} group of prediction candidate points. One group corresponds to one prediction point, an attribute value of a j^{th} prediction point is an attribute reconstruction value of a j^{th} group of points, and coordinates of the j^{th} prediction point are average geometric coordinates of the j^{th} group of points. P is a positive integer less than K, j is a positive integer less than or equal to P, and N is determined by using a maxNumOfNeighbours field. For example, assuming that each group has 100 points, where N=50, and P=10, prediction candidate points in the 11^{th} group may include not only the first 50 points of the 11^{th} group but also 10 prediction points corresponding to the first 10 groups. An attribute value of a prediction point corresponding to the fifth group is an attribute reconstruction value of the fifth group of points, and set coordinates of the prediction point corresponding to the fifth group are average geometric coordinates of the fifth group of points.

In another embodiment, in addition to using first N points in the (P+1)^{th} group as prediction candidate points of the (P+1)^{th} group, the computer device may further add a target prediction point to the (P+1)^{th} group of prediction candidate points. A value of the target prediction point is a weighted average of attribute reconstruction values of first P groups of points. When weights of the attribute reconstruction values of the first P groups of points are all 1, the value of the target prediction point is an average of the attribute reconstruction values of the first P groups of points. Coordinates of the target prediction point are average geometric coordinates of the first P groups of points. For example, assuming that each group has 100 points, where N=50, and P=10, prediction candidate points of the 11^{th} group may include not only the first 50 points in the 11^{th} group but also the target prediction point, and an attribute value of the target prediction point is a weighted average of attribute reconstruction values of the first P groups. When weights of the attribute reconstruction values of the first P groups of points are all 1, the value of the target prediction point is an average of the attribute reconstruction values of the first P groups of points. Coordinates of the target prediction point are average geometric coordinates of the first 10 groups.

In still another embodiment, in addition to using first N points in the (P+1)^{th} group as prediction candidate points of the (P+1)^{th} group, the computer device further replaces a to-be-replaced point in the (P+1)^{th} group of prediction candidate points with a target prediction point. A value of the target prediction point is a weighted average of attribute reconstruction values of first P groups of points. When weights of the attribute reconstruction values of the first P groups of points are all 1, the value of the target prediction point is an average of the attribute reconstruction values of the first P groups of points. Coordinates of the target prediction point are average geometric coordinates of the first P groups of points. The to-be-replaced point may include but is not limited to: the first point in the prediction candidate points, the last point in the prediction candidate points, or the farthest point in the prediction candidate points (a point farthest from the average geometric coordinates of the (P+1)^{th} group or a point farthest from the first point in the (P+1)^{th} group).

When a number of points in front of the (P+1)^{th} group is less than N (that is, a sum of numbers of points in the first P groups is less than a neighbor quantity threshold (maxNumOfNeighbours)), the computer device may use the P prediction points corresponding to the first P groups or the target prediction point as the prediction candidate point(s) in the (P+1)^{th} group, or may use the P prediction points corresponding to the first P groups or the target prediction point as neighbor point(s) of the (P+1)^{th} group for prediction.

In another implementation, the points in the point cloud data are grouped into K groups, and the K groups of points are arranged in encoding order, where K is an integer greater than 1. That the computer device optimizes a group prediction process based on an association relationship between groups includes optimizing obtaining of a secondary prediction residual value in the group prediction process. Specifically, the computer device obtains a residual value of each point in an i^{th} group, and the residual value of each point is calculated based on a primary prediction residual value and an attribute reconstruction value of the point, where i is a positive integer less than or equal to K. The computer device determines a reference residual value corresponding to the i^{th} group based on a residual value of at least one point in first i groups, and calculates a secondary prediction residual value based on the residual value of each point in the i^{th} group and the reference residual value corresponding to the i^{th} group.

A specific implementation in which the computer device determines the reference residual value corresponding to the i^{th} group based on the residual value of the at least one point in the first i groups may be any one of the following:

In an embodiment, the computer device may determine a residual value of any point in the first i groups as the reference residual value corresponding to the it group. For example, the computer device may use a residual value of the third point in an (i−2)^{th} group as the reference residual value corresponding to the i^{th} group. For another example, the computer device may use a residual value of the first point in the i^{th} group as the reference residual value corresponding to the i^{th} group.

In another embodiment, the computer device may calculate the reference residual value corresponding to the i^{th} group based on residual values of at least two points in the first i groups. Specifically, the computer device may determine a weighted average of the residual values of the at least two points in the first i groups (the weighted average is an average of the residual values of the at least two points in the first i groups when weights of residual values of all points in the first i groups are 1) as the reference residual value corresponding to the i^{th} group. For example, the computer may use a weighted average of residual values of the first points in first i−1 groups as the reference residual value corresponding to the i^{th} group. For another example, the computer device may use a weighted average of a residual value of the first point in an (i−1)^{th} group and a residual value of the last point in the (i−1)^{th} group as the reference residual value corresponding to the i^{th} group. For still another example, the computer device may determine a weighted average of a largest residual value and a smallest residual value in residual values of all points in the i^{th} group as the reference residual value corresponding to the i^{th} group.

In some embodiments, the computer device may alternatively calculate the reference residual value corresponding to the i^{th} group based on a sum of residual values of at least two points in the first i groups, a difference of residual values of at least two points in the first i groups, a logarithmic sum of residual values of at least two points in the first i groups, or the like. Details are not repeated herein.

In still another implementation, the points in the point cloud data are grouped into K groups, and the K groups of points are arranged in encoding order, where K is an integer greater than 1. That the computer device optimizes a group prediction process based on an association relationship between groups includes optimizing obtaining of a secondary transformation coefficient value in the group prediction process. Specifically, the computer device obtains a transformation coefficient value of each point in an i^{th} group, where i is a positive integer less than or equal to K. The computer device determines a reference transformation coefficient value of the i^{th} group based on a transformation coefficient value of at least one point in first i groups, and calculates a secondary transformation coefficient value based on the transformation coefficient value of each point in the i^{th} group and the reference transformation coefficient value of the it group.

A specific implementation in which the computer device determines the reference transformation coefficient value corresponding to the i^{th} group based on the transformation coefficient value of the at least one point in the first i groups may be any one of the following:

In an embodiment, the computer device may determine a transformation coefficient value of any point in first i−1 groups as the reference transformation coefficient value corresponding to the i^{th} group. For example, the computer device may use a transformation coefficient value of the third point in an (i−2)^{th} group as the reference transformation coefficient value corresponding to the it group. For another example, the computer device may use a transformation coefficient value of the first point in the i^{th} group as the reference transformation coefficient value corresponding to the i^{th} group.

In another embodiment, the computer device may calculate the reference transformation coefficient value of the i^{th} group based on transformation coefficient values of at least two points in the first i groups. Specifically, the computer device may determine a weighted average of the transformation coefficient values of the at least two points in the first i groups as the reference transformation coefficient value corresponding to the i^{th} group (when weights of transformation coefficient values of all points in the first i groups are all 1, the reference transformation coefficient value corresponding to the i^{th} group is an average of the transformation coefficient values of the at least two points in the first i groups). For example, the computer device may use a weighted average of transformation coefficient values of the first points in first i−1 groups as the reference transformation coefficient value corresponding to the i^{th} group. For another example, the computer device may use an average of a transformation coefficient value of the first point in an (i−1)^{th} group and a transformation coefficient value of the last point in the (i−1)^{th} group as the reference transformation coefficient value corresponding to the i^{th} group. For still another example, the computer device may determine a weighted average of a largest transformation coefficient value and a smallest transformation coefficient value in transformation coefficient values of all points in the i^{th} group as the reference transformation coefficient value corresponding to the i^{th} group.

In some embodiments, the computer device may alternatively calculate the reference transformation coefficient value corresponding to the i^{th} group based on a sum of transformation coefficient values of at least two points in the first i groups, a difference of transformation coefficient values of at least two points in the first i groups, a logarithmic sum of transformation coefficient values of at least two points in the first i groups, or the like. Details are not repeated herein.

S404: Encode the attribute information of the point cloud data to obtain code stream data of the point cloud data.

For a complete implementation in which the computer device encodes the attribute information of the point cloud data to obtain the code stream data of the point cloud data, refer to the implementation of the point cloud compression above. Details are not described herein again.

In an implementation, the computer device encodes the attribute information of the point cloud data based on the association relationship between the groups and a distribution feature of the attribute information of the point cloud data to obtain the code stream data of the point cloud data. Attribute information that is of the point cloud data and that corresponds to different encoding modes is different. For example, if encoding is performed in an attribute prediction mode, corresponding attribute information of the point cloud data includes a residual value. If encoding is performed in an attribute transformation mode, corresponding attribute information of the point cloud data includes a transformation coefficient value. If encoding is performed in a mode fusing the attribute prediction and the attribute transformation, corresponding attribute information of the point cloud data includes a residual value and a transformation coefficient value. The following describes different cases in detail:

In an embodiment, the attribute information of the point cloud data is a transformation coefficient, the points in the point cloud data are grouped into the K groups, each point in the it group is associated with R attributes, each attribute corresponds to M transformation coefficients, and the M transformation coefficients corresponding to each attribute include one first transformation coefficient (for example, DC transformation coefficient) and M−1 second transformation coefficients (for example, AC transformation coefficients). R is a positive integer, K and M are integers greater than 1, and i is a positive integer less than or equal to K. A process in which the computer device encodes the attribute information of the point cloud data based on the association relationship between the groups and the distribution feature of the attribute information of the point cloud data includes any one of the following implementations:

In an implementation, the computer device directly encodes the (R) first transformation coefficients in the i^{th} group, and performs run-length coding on the (R*(M−1)) second transformation coefficients in the i^{th} group.

The attribute information of the point cloud data may include at least one of the following: a residual value of each point or a transformation coefficient value of each point. With reference to this solution, the attribute information of the point cloud data may alternatively be attribute information (such as a secondary prediction residual value, a reference residual value, a secondary transformation coefficient value, a reference transformation coefficient value, a run-length, or a result obtained through shift-and-residue processing) that is of the point cloud data and that is obtained by optimizing the group prediction process based on the association relationship between the groups. For example, the attribute information of the point cloud data includes a first transformation coefficient and a second transformation coefficient of each point. Encoding/decoding modes for the first transformation coefficient and the second transformation coefficient may be the same or different. For example, during the encoding, code stream data corresponding to the first transformation coefficient is obtained by entropy encoding the first transformation coefficient; and code stream data corresponding to the second transformation coefficient is obtained by first performing inter-group run-length coding on the second transformation coefficient (based on the association relationship between the groups) and then performing intra-group run-length coding on a target group (for example, a group including a non-zero second transformation coefficient). In this case, during the decoding, the computer device entropy decodes the code stream data corresponding to the first transformation coefficient in the code stream data to obtain the first transformation coefficient of each point; and performs inter-group run-length decoding on the code stream data corresponding to the second transformation coefficient, and further performs intra-group run-length decoding on an the inter-group run-length decoding result to obtain the second transformation coefficient of each point. For another example, during the encoding, code stream data corresponding to the first transformation coefficient is obtained by entropy encoding the first transformation coefficient, and code stream data corresponding to the second transformation coefficient is obtained by performing intra-group run-length coding on the second transformation coefficient. In this case, during the decoding, the computer device entropy decodes the code stream data corresponding to the first transformation coefficient to obtain a shift-and-residue processing result, and then calculates the first transformation coefficient of each point based on the shift-and-residue processing result; and performs intra-group run-length decoding on the code stream data corresponding to the second transformation coefficient to obtain the second transformation coefficient of each point.

In an embodiment, a direct encoding mode includes entropy encoding the attribute information of the point cloud data. The computer device entropy encodes the attribute information of each point in the point cloud data to obtain S bits of data. The entropy encoding includes at least one of the following encoding modes: a context model-based encoding mode or a bypass encoding mode. The following describes specific implementations of the entropy encoding:

In an implementation, the computer device encodes the attribute information of each point in the point cloud data in the context model-based encoding mode to obtain the S bits of data. In an embodiment, the computer device encodes the attribute information of each point in the point cloud data by using a same context model to obtain the S bits of data. In another embodiment, the computer device encodes the attribute information of each point in the point cloud data by using different context models to obtain the S bits of data. Further, the S bits of data are divided into a first bit-of-data set and a second bit-of-data set. The computer device may indicate, during the encoding by using at least one preset value, a manner of dividing the S bits of data, and different bit-of-data sets correspond to different decoding modes. For example, the first bit-of-data set corresponds to a first context model-based encoding mode, and the second bit-of-data set corresponds to a second context model-based encoding mode.

In another implementation, the computer device encodes the attribute information of each point in the point cloud data in the bypass encoding mode to obtain the S bits of data. In an embodiment, the attribute information of the point cloud data includes a first attribute information set and a second attribute information set. During the encoding, the computer device may encode the first attribute information set and the second attribute information set in any two of the first context model-based encoding mode, the second context model-based encoding mode, and the bypass encoding mode to obtain first encoded data and second encoded data. For example, the computer device encodes attribute information in the first attribute information set in the first context model-based encoding mode to obtain the first encoded data, and encodes attribute information in the second attribute information set in the bypass encoding mode to obtain the second encoded data.

In another embodiment, the computer device first binarizes (for example, performs exp-Golomb encoding on) the attribute information of each point to obtain a binarization result, and then entropy encodes the binarization result to obtain S bits of data.

In an implementation, the computer device first performs shift-and-residue processing on the attribute information of each point to obtain a shift-and-residue processing result, then binarizes the shift-and-residue processing result to obtain a binarization result, and entropy encodes the binarization result to obtain the S bits of data.

In another implementation, the computer device performs run-length coding on the attribute information of each point to obtain the S bits of data, where S is a positive integer. The S bits of data indicate a run-length coding parameter, and the run-length coding parameter includes: a run-length and encoding information that is not a preset value (for example, 0) and that is in the attribute information of each point. An encoding mode for the attribute information that is not the preset value may include but is not limited to: a residual value-based encoding mode, a transformation coefficient-based encoding mode, and entropy encoding.

In still another implementation, the computer device may alternatively perform shift-and-residue processing on a run-length coding result to obtain the S bits of data, where S is a positive integer.

In another embodiment, the computer device may alternatively binarize a run-length coding result to obtain the S bits of data, where S is a positive integer.

In still another embodiment, the computer device may alternatively perform shift-and-residue processing on a run-length coding result to obtain a shift-and-residue result, and then binarize the shift-and-residue result to obtain the S bits of data, where S is a positive integer.

In another implementation, the computer device increases group run-lengths corresponding to the K groups of points by 1 if values of the (R*M) transformation coefficients in the i^{th} group are all a preset value (for example, 0). For example, assuming that a current group run-length is 3, and the values of the transformation coefficients in the i^{th} group are all the preset value, the computer device increases the current group run-length by 1. In this case, the group run-length is 4, and the computer device continues to encode the (i+1)^{th} group in the foregoing mode. If a value of at least one transformation coefficient in the transformation coefficients in the i^{th} group is not a preset value, group run-lengths corresponding to the K groups of points are zeroed, and the transformation coefficients in the i^{th} group are encoded one by one (for example, the transformation coefficients in the i^{th} group are directly encoded, or run-length coding is performed on the transformation coefficients in the i^{th} group. A specific encoding mode may be determined based on an actual requirement, and this is not limited in the present disclosure). For example, assuming that a current group run-length is 3, and a value of at least one transformation coefficient in transformation coefficients in the i^{th} group is not the preset value, the computer device zeros the current group run-length. In this case, the group run-length is 0, and run-length coding is performed on the transformation coefficients in the it group, or the transformation coefficients in the i^{th} group are directly encoded.

In still another implementation, the computer device encodes (for example, directly encodes or performs run-length coding on) the (R) first transformation coefficients in the it group; and increases group run-lengths corresponding to the K groups of points by 1 if values of the (R*(M−1)) second transformation coefficients in the i^{th} group are all a preset value (for example, 0). For example, assuming that a current group run-length is 5, and the values of the second transformation coefficients in the i^{th} group are all the preset value, the computer device increases the current group run-length by 1. In this case, the group run-length is 6, and the computer device continues to encode the (i+1)^{th} group in the foregoing mode. If a value of at least one second transformation coefficient in the second transformation coefficients in the i^{th} group is not a preset value, the computer device zeros group run-lengths corresponding to the K groups of points, and encodes the second transformation coefficients in the i^{th} group one by one (for example, directly encodes the second transformation coefficients in the i^{th} group, or performs run-length coding on the second transformation coefficients in the i^{th} group. A specific encoding mode may be determined based on an actual requirement, and this is not limited in the present disclosure). For example, assuming that a current group run-length is 5, and a value of at least one second transformation coefficient in the second transformation coefficients in the i^{th} group is not the preset value, the computer device zeros the current group run-length. In this case, the group run-length is 0, and the second transformation coefficients in the i^{th} group are directly encoded.

In still another implementation, the computer device performs shift-and-residue encoding on the (R) first transformation coefficients in the i^{th} group, and directly encodes the (R*(M−1)) second transformation coefficients in the i^{th} group.

In another embodiment, the points in the point cloud data are grouped into the K groups, the i^{th} group includes M points, each point is associated with R attributes, and each attribute corresponds to M transformation coefficients, where R is a positive integer, K and M are integers greater than 1, and i is a positive integer less than or equal to K. In an implementation, R is a number of pieces of attribute data associated with each point. For example, when there is a single piece of attribute data associated with each point, R=1. When there are multiple pieces of attribute data associated with each point, R>1. A specific process in which the computer device encodes the attribute information of the point cloud data based on the association relationship between the groups and the distribution feature of the attribute information of the point cloud data is as follows:

The computer device performs shift-and-residue encoding on a non-zero transformation coefficient in the i^{th} group if M is less than a third number threshold. The computer device directly encodes a non-zero transformation coefficient in the i^{th} group if M is greater than or equal to a third number threshold. For example, assuming that M=80 and the third number threshold is 50, the computer device directly encodes the non-zero transformation coefficient in the it group. Assuming that M=30 and the third number threshold is 50, the computer device performs shift-and-residue encoding on the non-zero transformation coefficient in the it group.

In still another embodiment, the points in the point cloud data are grouped into the K groups, an attribute of a j point in the i^{th} group includes Q component attributes, and each component attribute corresponds to one transformation coefficient, where Q is a positive integer, K is an integer greater than 1, i is a positive integer less than or equal to K, and j is a positive integer. A specific process in which the computer device encodes the attribute information of the point cloud data based on the association relationship between the groups and the distribution feature of the attribute information of the point cloud data is as follows:

The computer device calculates a sum of absolute values of at least two component attributes in the Q component attributes to obtain a component attribute merging value. For example, assuming that Q=3, the component attribute merging value may be a sum of an absolute value of the first component attribute and an absolute value of the second component attribute, a sum of the absolute value of the second component attribute and an absolute value of the third component attribute, a sum of the absolute value of the first component attribute and the absolute value of the third component attribute, or a sum of the absolute value of the first component attribute, the absolute value of the second component attribute, and the absolute value of the third component attribute. The computer device compares the component attribute merging value with a numerical threshold after obtaining the component attribute merging value. The computer device directly encodes a non-zero transformation coefficient in the transformation coefficients corresponding to the Q component attributes if the component attribute merging value is less than the numerical threshold. For example, assuming that the component attribute merging value is 3, the numerical threshold is 10, Q=3, transformation coefficients corresponding to the first component attribute and the second component attribute are 0, and a transformation coefficient corresponding to the third component attribute is not 0, the computer device directly encodes the transformation coefficient corresponding to the third component attribute. The computer device performs shift-and-residue encoding on a non-zero transformation coefficient in the transformation coefficients corresponding to the Q component attributes if the component attribute merging value is greater than or equal to the numerical threshold. For example, assuming that the component attribute merging value is 58, the numerical threshold is 10, Q=3, transformation coefficients corresponding to the first component attribute and the third component attribute are 0, and a transformation coefficient corresponding to the second component attribute is not 0, the computer device performs shift-and-residue encoding on the transformation coefficient corresponding to the second component attribute.

In this embodiment of the present disclosure, the to-be-encoded point cloud data is obtained; the points in the point cloud data are grouped to obtain the group information of the point cloud data; the group prediction process is optimized based on the association relationship between the groups to obtain the attribute information of the point cloud data; and the attribute information of the point cloud data is encoded based on the association relationship between the groups to obtain the code stream data of the point cloud data. It can be learned that the group prediction process is optimized based on the association relationship between the groups, so that a prediction result is closer to an actual result, to reduce an amount of data that needs to be encoded in an encoding phase, thereby improving efficiency of encoding the attribute information of a point cloud.

Refer to FIG. 5. FIG. 5 shows still another point cloud processing method according to an embodiment of the present disclosure. The point cloud processing method may be performed by a computer device, where the computer device may specifically be the decoding device 202 in the point cloud processing system 20 shown in FIG. 2. As shown in FIG. 5, the point cloud processing method may include S501 and S502:

S501: Obtain code stream data of point cloud data.

A manner in which the computer device obtains the code stream data of the point cloud data may be that the computer device obtains the code stream data from an encoding device in real time, or the computer device downloads the complete code stream data from the encoding device or a server.

S502: Decode the code stream data, and present the point cloud data based on a decoding result.

In an implementation, the code stream data includes S bits of data, and the S bits of data are obtained by encoding attribute information of each point in the point cloud data, where S is a positive integer. The attribute information of each point includes at least one of the following: a residual value or a transformation coefficient value. A process in which the computer device decodes the code stream data includes decoding the code stream data to obtain the attribute information of each point in the point cloud data. A specific implementation is, for example, any one of the following embodiments:

In an embodiment, the encoding device entropy encodes the attribute information of each point in the point cloud data to obtain the S bits of data. Correspondingly, the computer device entropy decodes the S bits of data to obtain the attribute information of each point in the point cloud data. The entropy encoding includes at least one of the following encoding modes: a context model-based encoding mode or a bypass encoding mode. Similarly, the entropy decoding includes at least one of the following decoding modes: a context model-based decoding mode or a bypass decoding mode. The following describes specific implementations of the entropy decoding.

In an implementation, the encoding device encodes the attribute information of each point in the point cloud data in the context model-based encoding mode to obtain the S bits of data. In an embodiment, the encoding device encodes the attribute information of each point in the point cloud data by using a same context model. Correspondingly, the computer device decodes the S bits of data by using a same context model to obtain the attribute information of each point in the point cloud data.

In another embodiment, the encoding device encodes the attribute information of each point in the point cloud data by using different context models. Correspondingly, the computer device decodes the S bits of data by using different context models to obtain the attribute information of each point in the point cloud data. Specifically, the S bits of data are divided into first encoded data and second encoded data. The encoding device may indicate, during the encoding by using at least one preset value, a manner of dividing the S bits of data. Correspondingly, the computer device determines the first encoded data and the second encoded data based on the at least one preset value; and decodes the first encoded data by using a first context model (for example, decodes a prefix code of the first encoded data by using a first context model corresponding to a prefix code in exp-Golomb decoding, and decodes a suffix code of the first encoded data by using a first context model corresponding to a suffix code in the exp-Golomb decoding), and decodes the second encoded data by using a second context model, to obtain the attribute information of each point in the point cloud data. The indicating, by using at least one preset value, a manner of dividing the S bits of data is described below by using an example: It is assumed that there is one preset value that is expressed as k (k may be the preset value or an exp-Golomb corresponding order value), where k is greater than or equal to 0 and less than S. In an exp-Golomb encoding mode, the S bits of data include S1 prefix codes and S2 suffix codes, where S=S1+S2. In other encoding modes, the S bits of data may be distinguished by using high bits (such as first S/2 bits) and low bits (such as last S/2 bits). The following provides descriptions by using the example in which the S bits of data include the S1 prefix codes and the S2 suffix codes. (1) In the S1 prefix codes, a k^{th} prefix code is obtained by encoding first target data by using a first context model, a (k+1)^{th} prefix code is obtained by encoding second target data by using a second context model, and a remaining prefix code is obtained by encoding third target data by using a third context model. In the S2 suffix codes, a k^{th} suffix code is obtained by encoding fourth target data by using a fourth context model, a (k+1)^{th} suffix code is obtained by encoding fifth target data by using a fifth context model, and a remaining suffix code is obtained by encoding sixth target data by using a sixth context model. Correspondingly, the computer device may decode the S bits of data by using the first context model to the sixth context model. (2) In the S1 prefix codes, a k^{th} prefix code is obtained by encoding first target data by using a first context model, a (k+1)^{th} prefix code is obtained by encoding second target data by using a second context model, a remaining prefix code is obtained by encoding third target data by using a third context model, and the S2 suffix codes are obtained by encoding fourth target data to sixth target data by using a fourth context model. Correspondingly, the computer device may decode the S bits of data by using the first context model to the fourth context model. (3) The S1 prefix codes are obtained by encoding first target data to third target data by using a first context model. In the S2 suffix codes, a k^{th} suffix code is obtained by encoding fourth target data by using a fourth context model, a (k+1)^{th} suffix code is obtained by encoding fifth target data by using a fifth context model, and a remaining suffix code is obtained by encoding sixth target data by using a sixth context model. Correspondingly, the computer device may decode the S bits by using the first context model and the fourth context model to the sixth context model. (4) In the S1 prefix codes, a kai prefix code is obtained by encoding first target data by using a first context model, a (k+1)^{th} prefix code is obtained by encoding second target data by using a second context model, and a remaining prefix code is obtained by encoding third target data by using a third context model. In the S2 suffix codes, a k^{th} suffix code is obtained by encoding fourth target data by using a fourth context model, a (k−1)^{th} suffix code is obtained by encoding fifth target data by using a fifth context model, and a remaining suffix code is obtained by encoding sixth target data by using a sixth context model. Correspondingly, the computer device may decode the S bits of data by using the first context model to the sixth context model. For details, refer to Table 4:

TABLE 4

| | | |
|---|---|---|
| Prefix code | s1 = k | First context model |
| | s1 = k + m | Second context model |
| | s1 is another bit | Third context model |
| Suffix code | s2 = k | Fourth context model |
| | s2 = k − n | Fifth context model |
| | s2 is another bit | Sixth context model |

k may be the preset value or the exp-Golomb corresponding order value, m and n are both greater than 1, and m and n may be the same or different. A prefix code bit is s1, and a suffix code bit is s2. The S bits of data include the S1 prefix codes and the S2 suffix codes, where S=S1+S2.

For another example, it is assumed that there are two preset values that are expressed as k1 and k2. In the S1 prefix codes, a k^{th} prefix code is obtained by encoding first target data by using a first context model, and a remaining prefix code is obtained by encoding second target data by using a second context model. In the S2 suffix codes, a k2^{th} suffix code is obtained by encoding third target data by using a third context model, and a remaining suffix code is obtained by encoding fourth target data by using a fourth context model.

For still another example, in the S1 prefix codes, prefix codes (such as the first prefix code to an mli prefix code, where m1 is a positive integer less than S1) belonging to a first set are obtained by encoding first target data by using a first context model, prefix codes (such as an (m1+1)^{th} prefix code to an m2^{th} prefix code, where m2 is a positive integer greater than m1 but less than S1) belonging to a second set are obtained by encoding second target data by using a second context model, and a remaining prefix code is obtained by encoding third target data by using a third context model. In the S2 suffix codes, suffix codes (such as the first suffix code to an m3^{th} suffix code, where m3 is a positive integer less than S2) belonging to a third set are obtained by encoding fourth target data by using a fourth context model, suffix codes (such as an (m3+1)^{th} suffix code to an m4^{th} suffix code, where m4 is a positive integer greater than m3 but less than S2) belonging to a fourth set are obtained by encoding fifth target data by using a fifth context model, and a remaining suffix code is obtained by encoding sixth target data by using a sixth context model. Correspondingly, the computer device may decode the S bits of data by using the first context model to the sixth context model. For details, refer to Table 5:

TABLE 5

| | | |
|---|---|---|
| Prefix code | 1 to m1 bits | First context model |
| | m1 + 1 to m2 bits | Second context model |
| | Another bit | Third context model |
| Suffix code | 1 to m3 bits | Fourth context model |
| | m3 + 1 to m4 bits | Fifth context model |
| | Another bit | Sixth context model |

m1 to m4 may be preset values; or m1 may be the exp-Golomb corresponding order value, and m3 may be obtained by using a length of the prefix code. Any one of the foregoing context model-based encoding and decoding modes may alternatively be replaced with the bypass encoding and decoding mode. Details are not described herein.

In still another embodiment, the encoding device may alternatively indicate, by using an exp-Golomb order, different context model combinations (which may include at least one context model) to be used during the encoding. For example, it is assumed that a target order is k1, a start order is k0, and the attribute information in the point cloud data includes: a first attribute information set, a second attribute information set, and a third attribute information set. When k0<k1, the encoding device may encode the first attribute information set by using a first context model combination. When k0=k1, the encoding device may encode the second attribute information set by using a second context model combination. When k0>k1, the encoding device may encode the third attribute information set by using a third context model combination. Correspondingly, the computer device may determine, based on the exp-Golomb order, context model combinations to be used for decoding different code stream data. For example, when decoding code stream data corresponding to the third attribute information set, the computer device determines, based on that k0>k1, to use the third context model combination to decode the code stream data corresponding to the third attribute information set.

In another implementation, the encoding device encodes the attribute information of each point in the point cloud data in the bypass encoding mode to obtain the S bits of data. Correspondingly, the computer device decodes the S bits of data in the bypass encoding mode to obtain the attribute information of each point in the point cloud data.

In an implementation, the attribute information of the point cloud data includes a first attribute information set and a second attribute information set. During the encoding, the encoding device may encode the first attribute information set and the second attribute information set in any two of the first context model-based encoding mode, the second context model-based encoding mode, and the bypass encoding mode to obtain the first encoded data and the second encoded data. Correspondingly, the computer device may decode the first encoded data and the second encoded data in corresponding decoding modes to obtain the first attribute information set and the second attribute information set. For example, the encoding device encodes attribute information in the first attribute information set in the first context model-based encoding mode to obtain the first encoded data, and encodes attribute information in the second attribute information set in the bypass encoding mode to obtain the second encoded data. In this case, the computer device decodes the first encoded data in a first context model-based decoding mode to obtain the first attribute information set, and decodes the second encoded data in the bypass decoding mode to obtain the second attribute information set.

In an embodiment, the encoding device first binarizes (for example, performs exp-Golomb encoding on) the attribute information of each point to obtain a binarization result, and then entropy encodes the binarization result to obtain the S bits of data. Correspondingly, the computer device entropy decodes the S bits of data to obtain the binarization result, and then restores the attribute information of each point in the point cloud data based on the binarization result. For example, assuming that the computer device entropy decodes the S bits of data to obtain a binarization result of a residual value of a point A: 011, the computer device restores the residual value of the point A as 3 based on the binarization result of the residual value of the point A.

In another embodiment, the encoding device first performs shift-and-residue processing on the attribute information of each point to obtain a shift-and-residue processing result, then binarizes the shift-and-residue processing result to obtain a binarization result, and entropy encodes the binarization result to obtain the S bits of data. Correspondingly, the computer device entropy decodes the S bits of data to obtain the binarization result, and then restores the shift-and-residue processing result based on the binarization result. The shift-and-residue processing result includes a quotient and a remainder of the attribute information of each point. After obtaining the shift-and-residue processing result, the computer device calculates the attribute information of each point in the point cloud data based on the quotient and the remainder of the attribute information of each point. The entropy encoding includes at least one of the following encoding modes: the context model-based encoding mode or the bypass encoding mode. Similarly, the entropy decoding includes at least one of the following decoding modes: the context model-based decoding mode or the bypass decoding mode. For example, assuming that a quotient of the residual value of the point A in the binarization result is: 010, and a remainder is: 001, after the binarization result is restored, the shift-and-residue processing result of the residual value of the point A is: a quotient is 2, and a remainder is 1. The residual value of the point A is calculated to be 5 by using the shift-and-residue processing result of the residual value of the point A.

In another implementation, the encoding device performs run-length coding on the attribute information of each point to obtain the S bits of data, where S is a positive integer. The S bits of data indicate a run-length coding parameter, and the run-length coding parameter includes: a run-length and encoding information that is not a preset value (for example, 0) and that is in the attribute information of each point. An encoding mode for the attribute information that is not the preset value may include but is not limited to: a residual value-based encoding mode, a transformation coefficient-based encoding mode, and entropy encoding. Correspondingly, the computer device performs run-length decoding on the S bits of data to obtain the attribute information of each point.

In an embodiment, the encoding device may alternatively perform shift-and-residue processing on a run-length coding result to obtain the S bits of data, where S is a positive integer. Correspondingly, during the decoding, the computer device first calculates the run-length coding parameter by using the shift-and-residue processing result, and then determines the attribute information of each point based on the run-length coding parameter.

In another embodiment, the encoding device may alternatively binarize a run-length coding result to obtain the S bits of data, where S is a positive integer. Correspondingly, during the decoding, the computer device first restores the run-length coding parameter by using a binarization result, and then determines the attribute information of each point based on the run-length coding parameter.

In still another embodiment, the encoding device may alternatively perform shift-and-residue processing on a run-length coding result to obtain a shift-and-residue result, and then binarize the shift-and-residue result to obtain the S bits of data, where S is a positive integer. Correspondingly, during the decoding, the computer device first restores the shift-and-residue result by using a binarization result, then calculates the run-length coding parameter by using the shift-and-residue processing result, and determines the attribute information of each point based on the run-length coding parameter.

In this embodiment of the application, the code stream data of the point cloud data is obtained, the code stream data is decoded, and the point cloud data is presented based on the decoding result. In the decoding process, the code stream data may be decoded in one or more decoding modes corresponding to the encoding mode. The decoding mode may be determined by using indication information corresponding to a preprocessing mode. The manner of dividing the code stream data may be determined by using the at least one preset value. Efficiency of decoding the attribute information of a point cloud can be improved by using the foregoing method.

Refer to FIG. 6. FIG. 6 shows yet another point cloud processing method according to an embodiment of the present disclosure. The point cloud processing method may be performed by a computer device, where the computer device may specifically be the encoding device 201 in the point cloud processing system 20 shown in FIG. 2. As shown in FIG. 6, the point cloud processing method may include S601 and S602:

S601: Obtain to-be-encoded point cloud data.

For a specific implementation of S601, refer to the implementation of S401 in FIG. 4. Details are not described herein again.

S602: Encode the to-be-encoded point cloud data to obtain code stream data of the point cloud data.

In an implementation, a process of encoding the to-be-encoded point cloud data by the computer device includes encoding attribute information of each point in the point cloud data to obtain S bits of data, where S is a positive integer. The attribute information of each point includes at least one of the following: a residual value or a transformation coefficient value. A specific implementation is, for example, any one of the following embodiments:

In an embodiment, the computer device entropy encodes the attribute information of each point in the point cloud data to obtain the S bits of data. The entropy encoding includes at least one of the following encoding modes: a context model-based encoding mode or a bypass encoding mode. The following describes specific implementations of the entropy encoding.

In an implementation, the computer device encodes the attribute information of each point in the point cloud data in the context model-based encoding mode to obtain the S bits of data. In an embodiment, the computer device encodes the attribute information of each point in the point cloud data by using a same context model to obtain the S bits of data. In another embodiment, the computer device encodes the attribute information of each point in the point cloud data by using different context models to obtain the S bits of data. Further, the S bits of data are divided into a first bit-of-data set and a second bit-of-data set. The computer device may indicate, during the encoding by using at least one preset value, a manner of dividing the S bits of data, and different bit-of-data sets correspond to different decoding modes. For example, the first bit-of-data set corresponds to a first context model-based encoding mode, and the second bit-of-data set corresponds to a second context model-based encoding mode.

In another implementation, the computer device encodes the attribute information of each point in the point cloud data in the bypass encoding mode to obtain the S bits of data. In an embodiment, the attribute information of the point cloud data includes a first attribute information set and a second attribute information set. During the encoding, the computer device may encode the first attribute information set and the second attribute information set in any two of a first context model-based encoding mode, a second context model-based encoding mode, and the bypass encoding mode to obtain first encoded data and second encoded data. For example, the computer device encodes attribute information in the first attribute information set in the first context model-based encoding mode to obtain the first encoded data, and encodes attribute information in the second attribute information set in the bypass encoding mode to obtain the second encoded data.

In another embodiment, the computer device first binarizes (for example, performs exp-Golomb encoding on) the attribute information of each point to obtain a binarization result, and then entropy encodes the binarization result to obtain the S bits of data.

In an implementation, the computer device first performs shift-and-residue processing on the attribute information of each point to obtain a shift-and-residue processing result, then binarizes the shift-and-residue processing result to obtain a binarization result, and entropy encodes the binarization result to obtain the S bits of data.

In another implementation, the computer device performs run-length coding on the attribute information of each point to obtain the S bits of data, where S is a positive integer. The S bits of data indicate a run-length coding parameter, and the run-length coding parameter includes: a run-length and encoding information that is not a preset value (for example, 0) and that is in the attribute information of each point. An encoding mode for the attribute information that is not the preset value may include but is not limited to: a residual value-based encoding mode, a transformation coefficient-based encoding mode, and entropy encoding.

In still another implementation, the computer device may alternatively perform shift-and-residue processing on a run-length coding result to obtain the S bits of data, where S is a positive integer.

In another embodiment, the computer device may alternatively binarize a run-length coding result to obtain the S bits of data, where S is a positive integer.

In still another embodiment, the computer device may alternatively perform shift-and-residue processing on a run-length coding result to obtain a shift-and-residue result, and then binarize the shift-and-residue result to obtain the S bits of data, where S is a positive integer.

In this embodiment of the present disclosure, the to-be-encoded point cloud data is obtained, and is encoded to obtain the code stream data of the point cloud data. In the encoding process, the attribute information of the point cloud data may be encoded in one or more encoding modes. Alternatively, the attribute information of the point cloud data may be first preprocessed, and then a preprocessing result is encoded. A preprocessing mode may be indicated by indication information, and the manner of dividing the code stream data may be indicated by the at least one preset value. Efficiency of encoding the attribute information of a point cloud can be improved by using the foregoing method.

The method in the embodiments of the present disclosure is described in detail above. Correspondingly, an apparatus in the embodiments of the present disclosure is provided below to better implement the foregoing solutions in the embodiments of the present disclosure.

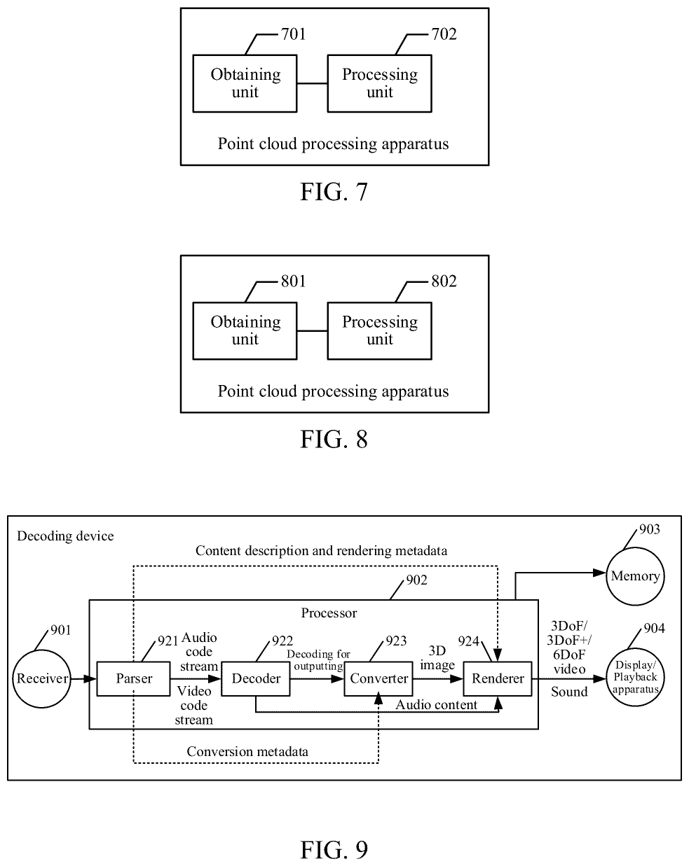

Refer to FIG. 7. FIG. 7 is a schematic structural diagram of a point cloud processing apparatus according to an embodiment of the present disclosure. The point cloud processing apparatus may be a computer program (including program code) running in a decoding device. For example, the point cloud processing apparatus may be application software in the decoding device. As shown in FIG. 7, the point cloud processing apparatus includes an obtaining unit 701 and a processing unit 702.

Refer to FIG. 7. In an exemplary embodiment, the units are described in detail as follows:

The obtaining unit 701 is configured to obtain code stream data of point cloud data.

The processing unit 702 is configured to: parse the code stream data to obtain group information of the point cloud data, the group information indicating an association relationship between groups corresponding to the point cloud data;
optimize a group prediction process based on the association relationship between the groups, to obtain attribute information of the point cloud data; and
present the point cloud data based on the attribute information of the point cloud data.

In an implementation, points in the point cloud data are grouped into K groups, and the K groups of points are arranged in decoding order, where K is an integer greater than 1. The optimization includes optimizing selection of a prediction candidate point in the group prediction process. A method for optimizing the selection by the processing unit 702 includes at least one of the following:
adding a target prediction point to a (P+1)^{th} group of prediction candidate points, a value of the target prediction point being a weighted average of attribute reconstruction values of first P groups of points, and coordinates of the target prediction point being average geometric coordinates of the first P groups of points;
replacing a to-be-replaced point in the (P+1)^{th} group of prediction candidate points with the target prediction point; or
using the target prediction point as a prediction candidate point in the (P+1)^{th} group if a sum of numbers of points in the first P groups is less than a neighbor quantity threshold.

In an implementation, points in the point cloud data are grouped into K groups, where K is an integer greater than 1. The optimization includes optimizing obtaining of a residual value in the group prediction process. The optimization of the obtaining of the residual value includes: obtaining a secondary prediction residual value and a reference residual value that correspond to an i^{th} group, i being a positive integer less than or equal to K; and calculating a residual value of each point in the i^{th} group based on the secondary prediction residual value and the reference residual value.

In an implementation, the K groups of points are arranged in decoding order, and that the processing unit 702 is configured to obtain a secondary prediction residual value and a reference residual value that correspond to an it group specifically includes:
parsing the code stream data to obtain the secondary prediction residual value and the reference residual value that correspond to the it group; or
parsing the code stream data to obtain the secondary prediction residual value corresponding to the i^{th} group, and determining the reference residual value corresponding to the it group based on a residual value of at least one point in first i groups.

In an implementation, that the processing unit 702 is configured to determine the reference residual value corresponding to the i^{th} group based on a residual value of at least one point in first i groups specifically includes:
determining a residual value of any point in the first i groups as the reference residual value corresponding to the it group; or
calculating the reference residual value corresponding to the i^{th} group based on residual values of at least two points in the first i groups.

In an implementation, points in the point cloud data are grouped into K groups, where K is an integer greater than 1. The optimization includes optimizing obtaining of a transformation coefficient value in the group prediction process. The optimization of the obtaining of the transformation coefficient value includes:
obtaining a secondary transformation coefficient value and a reference transformation coefficient value that correspond to an i^{th} group, i being a positive integer less than or equal to K; and
calculating a transformation coefficient value of each point in the i^{th} group based on the secondary transformation coefficient value and the reference transformation coefficient value.

In an implementation, the K groups of points are arranged in decoding order, and that the processing unit 702 is configured to obtain a secondary transformation coefficient value and a reference transformation coefficient value that correspond to an it group specifically includes: parsing the code stream data to obtain the secondary transformation coefficient value and the reference transformation coefficient value that correspond to the it group; or parsing the code stream data to obtain the secondary transformation coefficient value corresponding to the i^{th} group, and determining the reference transformation coefficient value corresponding to the i^{th} group based on a coefficient value of at least one point in first i groups.

In an implementation, that the processing unit 702 is configured to determine the reference transformation coefficient value corresponding to the i^{th} group based on a coefficient value of at least one point in first i groups specifically includes:
determining a transformation coefficient value of any point in the first i groups as the reference transformation coefficient value of the i^{th} group; or
calculating the reference transformation coefficient value of the i^{th} group based on transformation coefficient values of at least two points in the first i groups.

In an implementation, points in the point cloud data are grouped into K groups, each point in an i^{th} group is associated with R attributes, each attribute corresponds to M transformation coefficients, and the M transformation coefficients corresponding to each attribute include one first transformation coefficient and M−1 second transformation coefficients, where R is a positive integer, K and M are integers greater than 1, and i is a positive integer less than or equal to K. The processing unit 702 is further configured to:
directly decode the first transformation coefficient in the i^{th} group, and perform intra-group run-length decoding on the second transformation coefficient in the i^{th} group;
perform inter-group run-length decoding on the transformation coefficients in the i^{th} group if a group run-length corresponding to the i^{th} group is not 0; or decode the transformation coefficients in the i^{th} group one by one if a group un-length corresponding to the i^{th} group is 0;
directly decode the first transformation coefficient in the it group; and perform inter-group run-length decoding on the second transformation coefficient in the i^{th} group if a group run-length corresponding to the i^{th} group is not 0; or decode the second transformation coefficient in the i^{th} group one by one if a group run-length corresponding to the i^{th} group is 0; or
perform shift-and-residue decoding on the first transformation coefficient in the i^{th} group, and directly decode the second transformation coefficient in the i^{th} group.

In an implementation, points in the point cloud data are grouped into K groups, an i^{th} group includes M points, each point is associated with R attributes, and each attribute corresponds to M transformation coefficients, where R is a positive integer, K and M are integers greater than 1, and i is a positive integer less than or equal to K. The processing unit 702 is further configured to:
perform shift-and-residue decoding on a non-zero transformation coefficient in the i^{th} group; or
directly decode a non-zero transformation coefficient in the i^{th} group.

In an implementation, points in the point cloud data are grouped into K groups, an attribute of a j^{th} point in an i^{th} group includes Q component attributes, and each component attribute corresponds to one transformation coefficient, where Q is a positive integer, K is an integer greater than 1, i is a positive integer less than or equal to K, and j is a positive integer. The processing unit 702 is further configured to:
directly decode a non-zero transformation coefficient in the transformation coefficients corresponding to the Q component attributes; or
perform shift-and-residue decoding on a non-zero transformation coefficient in the transformation coefficients corresponding to the Q component attributes.

In an implementation, the code stream data includes S bits of data, where S is a positive integer. The processing unit 702 is further configured to:
entropy decode the S bits of data to obtain the attribute information of the point cloud data; or
perform run-length decoding on the S bits of data to obtain the attribute information of the point cloud data, where
the entropy decoding includes at least one of the following decoding modes: a context model-based decoding mode or a bypass decoding mode; and the attribute information of the point cloud data includes at least one of the following: a residual value of each point or a transformation coefficient of each point.

In an implementation, the entropy decoding includes the context model-based decoding mode and the bypass decoding mode, where the context model-based decoding mode includes a first context model-based decoding mode and a second context model-based decoding mode. The S bits of data include first encoded data and second encoded data. A process of entropy decoding the S bits of data by the processing unit 702 includes:
decoding the first encoded data in the context model-based decoding mode, and decoding the second encoded data in the bypass decoding mode; or
decoding the first encoded data in the first context model-based decoding mode, and decoding the second encoded data in the second context model-based decoding mode.

In an implementation, the first encoded data and the second encoded data are obtained by dividing the S bits of data based on at least one preset value.

In an implementation, that the processing unit 702 is configured to entropy decode the S bits of data to obtain the attribute information of the point cloud data specifically includes:
entropy decoding the S bits of data to obtain a binarization result; and
restoring the attribute information of the point cloud data based on the binarization result.

In an implementation, that the processing unit 702 is configured to restore the attribute information of the point cloud data based on the binarization result specifically includes:
restoring a shift-and-residue processing result based on the binarization result; and
calculating the attribute information of the point cloud data based on the shift-and-residue processing result.

According to an embodiment of the present disclosure, some operations in the point cloud processing methods shown in FIG. 3 and FIG. 5 may be performed by the units in the point cloud processing apparatus shown in FIG. 7. For example, S301 shown in FIG. 3 may be performed by the obtaining unit 701 shown in FIG. 7, and S302 to S304 may be performed by the processing unit 702 shown in FIG. 7. S501 shown in FIG. 5 may be performed by the obtaining unit 701 shown in FIG. 7, and S502 may be performed by the processing unit 702 shown in FIG. 7. The units in the point cloud processing apparatus shown in FIG. 7 may be separately or completely combined into one or more other units, or one (or more) of the units may be split into multiple units with smaller functions. In this way, same operations can be implemented, and implementation of the technical effects of the embodiments of the present disclosure is not affected. The foregoing units are obtained through division based on logical functions. In an actual application, a function of one unit may be implemented by multiple units, or functions of multiple units may be implemented by one unit. In other embodiments of the present disclosure, the point cloud processing apparatus may also include another unit. During practical application, these functions may alternatively be cooperatively implemented by another unit and may be implemented with collaboration by multiple units.

According to another embodiment of the present disclosure, the point cloud processing apparatus shown in FIG. 7 may be constructed and the point cloud processing method in the embodiments of the present disclosure may be implemented by running a computer program (including program code) that can be configured to perform the operations in the corresponding methods shown in FIG. 3 and FIG. 5 on a general-purpose computing apparatus, for example, a computer, including processing elements and storage elements such as a central processing unit (CPU), a random access memory (RAM), and a read-only memory (ROM). The computer program may be recorded in, for example, a computer-readable recording medium, and may be loaded into the foregoing computing apparatus via the computer-readable recording medium and run in the computing apparatus.

Based on the same inventive concept, the problem-solving principle and beneficial effects of the point cloud processing apparatus provided in the embodiments of the present disclosure are similar to those of the point cloud processing method in the method embodiments of the present disclosure. Refer to the principle and beneficial effects of the implementation of the method. For brevity, details are not described herein again.

Refer to FIG. 8. FIG. 8 is a schematic structural diagram of another point cloud processing apparatus according to an embodiment of the present disclosure. The point cloud processing apparatus may be a computer program (including program code) running in an encoding device. For example, the point cloud processing apparatus may be application software in the encoding device. As shown in FIG. 8, the point cloud processing apparatus includes an obtaining unit 801 and a processing unit 802. Refer to FIG. 8. The units are described in detail as follows:

The obtaining unit 801 is configured to obtain to-be-encoded point cloud data.

The processing unit 802 is configured to: group points in the point cloud data to obtain group information of the point cloud data, the group information indicating an association relationship between groups corresponding to the point cloud data;
optimize a group prediction process based on the association relationship between the groups, to obtain attribute information of the point cloud data; and
encode the attribute information of the point cloud data to obtain code stream data of the point cloud data.

In an implementation, that the processing unit 802 is configured to group points in the point cloud data to obtain group information of the point cloud data specifically includes:
grouping the points in the point cloud data based on a space filling curve to obtain the group information of the point cloud data,
a coordinate arrangement order of the space filling curve being determined based on a three-dimensional frame to which the point cloud data belongs.

In an implementation, that the processing unit 802 is configured to group the points in the point cloud data based on a space filling curve to obtain the group information of the point cloud data specifically includes:
grouping the points in the point cloud data into K groups based on the space filling curve, K being an integer greater than 1;
if a number of points in an i^{th} group is greater than a first number threshold, grouping, into one group, points that are in the i^{th} group and whose coordinate values in a target direction belong to a numerical interval, the target direction being a direction corresponding to a side with a shortest side length in a three-dimensional frame to which points in the i^{th} group belong, and i being a positive integer less than or equal to K; and
increasing or decreasing the number of points in the i^{th} group by 1 if the number of points in the i^{th} group is odd.

In an implementation, the K groups of points are arranged in encoding order, and the processing unit 802 is further configured to:
merge the i^{th} group and an adjacent group of the i^{th} group to obtain a merged group if the number of points in the i^{th} group is less than a second number threshold N, the second number threshold N being less than the first number threshold, and N being a positive integer; and
evenly divide the merged group to obtain an updated i^{th} group and an updated adjacent group of the i^{th} group; or group N points in the merged group into an i^{th} group, and group points other than the N points in the merged group into an adjacent group of the i^{th} group.

In an implementation, the points in the point cloud data are grouped into K groups, where K is an integer greater than 1. The optimization includes optimizing selection of a prediction candidate point in the group prediction process. A method for optimizing the selection by the processing unit 802 includes at least one of the following:
adding a target prediction point to a (P+1)^{th} group of prediction candidate points, a value of the target prediction point being a weighted average of attribute reconstruction values of first P groups of points, and coordinates of the target prediction point being average geometric coordinates of the first P groups of points;
replacing a to-be-replaced point in the (P+1)^{th} group of prediction candidate points with the target prediction point; or
using the target prediction point as a prediction candidate point in the (P+1)^{th} group if a sum of numbers of points in the first P groups is less than a neighbor quantity threshold.

In an implementation, the points in the point cloud data are grouped into K groups, and the K groups of points are arranged in encoding order, where K is an integer greater than 1. The optimization includes optimizing obtaining of a secondary prediction residual value in the group prediction process, and that the processing unit 802 optimizes obtaining of a secondary prediction residual value includes:
obtaining a residual value of each point in an i^{th} group, where the residual value of each point is calculated based on a primary prediction residual value and an attribute reconstruction value of the point, where i is a positive integer less than or equal to K;
determining a reference residual value corresponding to the i^{th} group based on a residual value of at least one point in first i groups; and
calculating the secondary prediction residual value based on the residual value of each point in the i^{th} group and the reference residual value corresponding to the it group.

In an implementation, that the processing unit 802 is configured to determine a reference residual value corresponding to the i^{th} group based on a residual value of at least one point in first i groups specifically includes:
determining a residual value of any point in the first i groups as the reference residual value corresponding to the it group; or
calculating the reference residual value corresponding to the i^{th} group based on residual values of at least two points in the first i groups.

In an implementation, the points in the point cloud data are grouped into K groups, and the K groups of points are arranged in encoding order, where K is an integer greater than 1. The optimization includes optimizing obtaining of a secondary transformation coefficient value in the group prediction process, and that the processing unit 802 optimizes obtaining of a secondary prediction transformation coefficient value includes:
obtaining a transformation coefficient value of each point in an i^{th} group, where i is a positive integer less than or equal to K;
determining a reference transformation coefficient value of the i^{th} group based on a transformation coefficient value of at least one point in first i groups; and
calculating the secondary transformation coefficient value based on the transformation coefficient value of each point in the i^{th} group and the reference transformation coefficient value of the i^{th} group.

In an implementation, that the processing unit 802 is configured to determine a reference transformation coefficient value of the i^{th} group based on a transformation coefficient value of at least one point in first i groups specifically includes:
determining a transformation coefficient value of any point in the first i groups as the reference transformation coefficient value of the i^{th} group; or
calculating the reference transformation coefficient value of the i^{th} group based on transformation coefficient values of at least two points in the first i groups.

In an implementation, that the processing unit 802 is configured to encode the attribute information of the point cloud data to obtain code stream data of the point cloud data specifically includes:
encoding the attribute information of the point cloud data based on the association relationship between the groups and a distribution feature of the attribute information of the point cloud data to obtain the code stream data of the point cloud data.

In an implementation, the attribute information of the point cloud data is a transformation coefficient, the points in the point cloud data are grouped into K groups, each point in an i^{th} group is associated with R attributes, each attribute corresponds to M transformation coefficients, and the M transformation coefficients corresponding to each attribute include one first transformation coefficient and M−1 second transformation coefficients. R is a positive integer, K and M are integers greater than 1, and i is a positive integer less than or equal to K. A process in which the processing unit 802 encodes the attribute information of the point cloud data based on the association relationship between the groups and the distribution feature of the attribute information of the point cloud data includes:
directly encoding the first transformation coefficient in the i^{th} group, and performing run-length coding on the second transformation coefficient in the i^{th} group;
increasing group run-lengths corresponding to the K groups of points by 1 if values of the transformation coefficients in the i^{th} group are all a preset value; or if a value of at least one transformation coefficient in the transformation coefficients in the i^{th} group is not a preset value, zeroing group run-lengths corresponding to the K groups of points, and encoding the transformation coefficients in the i^{th} group one by one;
directly encoding the first transformation coefficient in the i^{th} group; and increasing group run-lengths corresponding to the K groups of points by 1 if values of the second transformation coefficients in the i^{th} group are all a preset value; or if a value of at least one second transformation coefficient in the second transformation coefficients in the i^{th} group is not a preset value, zeroing group run-lengths corresponding to the K groups of points, and encoding the second transformation coefficients in the i^{th} group one by one; or
performing shift-and-residue encoding on the first transformation coefficient in the i^{th} group, and directly encoding the second transformation coefficient in the it group.

In an implementation, the points in the point cloud data are grouped into K groups, an i^{th} group includes M points, each point is associated with R attributes, and each attribute corresponds to M transformation coefficients, where R is a positive integer, K and M are integers greater than 1, and i is a positive integer less than or equal to K. A process in which the processing unit 802 encodes the attribute information of the point cloud data based on the association relationship between the groups and a distribution feature of the attribute information of the point cloud data includes:
performing shift-and-residue encoding on a non-zero transformation coefficient in the transformation coefficients in the i^{th} group if M is less than a third number threshold; or
directly encoding a non-zero transformation coefficient in the transformation coefficients in the i^{th} group if M is greater than or equal to the third number threshold.

In an implementation, the points in the point cloud data are grouped into K groups, an attribute of a j^{th} point in an i^{th} group includes Q component attributes, and each component attribute corresponds to one transformation coefficient, where K is an integer greater than 1, Q is a positive integer, i is a positive integer less than or equal to K, and j is a positive integer. A process in which the processing unit 802 encodes the attribute information of the point cloud data based on the association relationship between the groups and a distribution feature of the attribute information of the point cloud data includes:
calculating a sum of absolute values of at least two component attributes in the Q component attributes to obtain a component attribute merging value; and
directly encoding a non-zero transformation coefficient in the transformation coefficients corresponding to the Q component attributes if the component attribute merging value is less than a numerical threshold; or
performing shift-and-residue encoding on a non-zero transformation coefficient in the transformation coefficients corresponding to the Q component attributes if the component attribute merging value is greater than or equal to the numerical threshold.

In an implementation, the attribute information of the point cloud data includes at least one of the following: a residual value of each point or a transformation coefficient of each point; and a process in which the processing unit 802 encodes the attribute information of the point cloud data includes:
entropy encoding the attribute information of the point cloud data to obtain S bits of data, S being a positive integer; or
performing run-length coding on the attribute information of the point cloud data to obtain S bits of data,
the entropy encoding including at least one of the following encoding modes: a context model-based encoding mode or a bypass encoding mode.

In an implementation, the entropy encoding includes the context model-based encoding mode and the bypass encoding mode; the context model-based encoding mode includes a first context model-based encoding mode and a second context model-based encoding mode; and the attribute information of the point cloud data includes a first attribute information set and a second attribute information set. A process in which the processing unit 802 entropy encodes the attribute information of the point cloud data includes:
encoding attribute information in the first attribute information set in the context model-based encoding mode, and encoding attribute information in the second attribute information set in the bypass encoding mode; or
encoding attribute information in the first attribute information set in the first context model-based encoding mode, and encoding attribute information in the second attribute information set in the second context model-based encoding mode.

In an implementation, the S bits of data include first encoded data and second encoded data. The first encoded data and the second encoded data are obtained by dividing the S bits of data based on at least one preset value.

In an implementation, that the processing unit 802 is configured to entropy encode the attribute information of the point cloud data to obtain S bits of data specifically includes:
binarizing the attribute information of the point cloud data to obtain a binarization result; and
entropy encoding the binarization result to obtain the S bits of data.

In an implementation, that the processing unit 802 is configured to binarize the attribute information of the point cloud data to obtain a binarization result specifically includes:
performing shift-and-residue processing on the attribute information of the point cloud data to obtain a shift-and-residue processing result; and
binarizing the shift-and-residue processing result, to obtain the binarization result.

According to an embodiment of the present disclosure, some operations in the point cloud processing methods shown in FIG. 4 and FIG. 6 may be performed by the units of the point cloud processing apparatus shown in FIG. 8. For example, S401 shown in FIG. 4 may be performed by the obtaining unit 801 shown in FIG. 8, and S402 to S404 may be performed by the processing unit 802 shown in FIG. 8. S601 shown in FIG. 6 may be performed by the obtaining unit 801 shown in FIG. 8, and S602 may be performed by the processing unit 802 shown in FIG. 8. The units in the point cloud processing apparatus shown in FIG. 8 may be separately or completely combined into one or more other units, or one (or more) of the units may be split into multiple units with smaller functions. In this way, same operations can be implemented, and implementation of the technical effects of the embodiments of the present disclosure is not affected. The foregoing units are obtained through division based on logical functions. In an actual application, a function of one unit may be implemented by multiple units, or functions of multiple units may be implemented by one unit. In other embodiments of the present disclosure, the point cloud processing apparatus may also include another unit. During practical application, these functions may alternatively be cooperatively implemented by another unit and may be implemented with collaboration by multiple units.

As used herein, the term unit (and other similar terms such as subunit, module, submodule, etc.) in the present disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

According to another embodiment of the present disclosure, the point cloud processing apparatus shown in FIG. 8 may be constructed and the point cloud processing method in the embodiments of the present disclosure may be implemented by running a computer program (including program code) that can be configured to perform the operations in the corresponding methods shown in FIG. 4 and FIG. 6 on a general-purpose computing apparatus, for example, a computer, including processing elements and storage elements such as a CPU, a RAM, and a ROM. The computer program may be recorded in, for example, a computer-readable recording medium, and may be loaded into the foregoing computing apparatus via the computer-readable recording medium and run in the computing apparatus.

Based on the same inventive concept, the problem-solving principle and beneficial effects of the point cloud processing apparatus provided in the embodiments of the present disclosure are similar to those of the point cloud processing method in the method embodiments of the present disclosure. Refer to the principle and beneficial effects of the implementation of the method. For brevity, details are not described herein again.

FIG. 9 is a schematic structural diagram of a decoding device according to an embodiment of the present disclosure. The decoding device may be a computer device used by a user of point cloud media, and the computer device may be a terminal (for example, a PC, an intelligent mobile device (for example, a smartphone), or a VR device (for example, a VR helmet or VR glasses)). As shown in FIG. 9, the decoding device includes a receiver 901, a processor 902, a memory 903, and a display/playback apparatus 904.

The receiver 901 is configured to implement transmission interaction between the decoding device and another device, and is specifically configured to implement point cloud media transmission between an encoding device and the decoding device. That is, the decoding device receives, through the receiver 901, a related media resource for the encoding device to transmit point cloud media.

The processor 902 (or referred to as a CPU) is a processing core of the decoding device, and the processor 902 is adapted to implementing one or more program instructions, and is specifically adapted to loading and executing the one or more program instructions, to implement the procedures for the point cloud processing methods shown in FIG. 3 and FIG. 5.

The memory 903 is a memory component in the decoding device, and is configured to store a program and the media resource. The memory 903 herein may include an internal storage medium of the decoding device, and may also include an expanded storage medium supported by the decoding device. The memory 903 may be a high-speed RAM, or may be a non-volatile memory, for example, at least one magnetic disk memory. In some embodiments, the memory 903 may be at least one memory that is far away from the foregoing processor. The memory 903 provides storage space for storing an operating system of the decoding device. In addition, the storage space is further configured to store a computer program. The computer program includes program instructions, and the program instructions are adapted to being called and executed by the processor to perform the operations of the point cloud processing method. In addition, the memory 903 may also be configured to store a three-dimensional image that is of the point cloud media and that is formed through processing by the processor, audio content corresponding to the three-dimensional image, information required for rendering the three-dimensional image and the audio content, and the like.

The display/playback apparatus 904 is configured to output sound and a three-dimensional image that are obtained through rendering.

Refer to FIG. 9 again. The processor 902 may include a parser 921, a decoder 922, a converter 923, and a renderer 924.

The parser 921 is configured to decapsulate an encapsulated file of rendering media from the encoding device. Specifically, the parser 921 decapsulates a media file resource based on a file format requirement of the point cloud media to obtain an audio code stream and a video code stream, and provides the audio code stream and the video code stream to the decoder 922.

The decoder 922 performs audio decoding on the audio code stream to obtain audio content, and provides the audio content to the renderer for audio rendering. In addition, the decoder 922 decodes the video code stream to obtain a 2D image. According to metadata provided by media presentation description information, if the metadata indicates that a region encapsulation process has been performed on the point cloud media, the 2D image is an encapsulated image. If the metadata indicates that a region encapsulation process has not been performed on the point cloud media, the plane image is a projected image.

The converter 923 is configured to convert the 2D image into a 3D image. If the region encapsulation process has been performed on the point cloud media, the converter 923 further performs region decapsulation on the encapsulated image to obtain the projected image, and then performs reconstruction processing on the projected image to obtain the 3D image. If the region encapsulation process has not been performed on the rendering media, the converter 923 directly reconstructs the projected image into the 3D image.

The renderer 924 is configured to render the audio content and the 3D image of the point cloud media. Specifically, the renderer 924 renders the audio content and the 3D image based on rendering and window related metadata in the media presentation description information, and sends the rendered audio content and 3D image to the display/playback apparatus for outputting.

In an exemplary embodiment, the processor 902 (specifically, each component included in the processor) calls one or more instructions in the memory to perform the operations of the point cloud processing method shown in FIG. 3 or FIG. 5. Specifically, the memory stores one or more first instructions, and the one or more first instructions are adapted to being loaded by the processor 902 to perform the following operations:
obtaining code stream data of point cloud data;
parsing the code stream data to obtain group information of the point cloud data, the group information indicating an association relationship, related to encoding and decoding, between groups corresponding to the point cloud data;
optimizing a group prediction process based on the association relationship between the groups, to obtain attribute information of the point cloud data; and
presenting the point cloud data based on the attribute information of the point cloud data.

Based on the same inventive concept, the problem-solving principle and beneficial effects of the decoding device provided in this embodiment of the present disclosure are similar to those of the point cloud processing method in the method embodiments of the present disclosure. Refer to the principle and beneficial effects of the implementation of the method. For brevity, details are not described herein again.

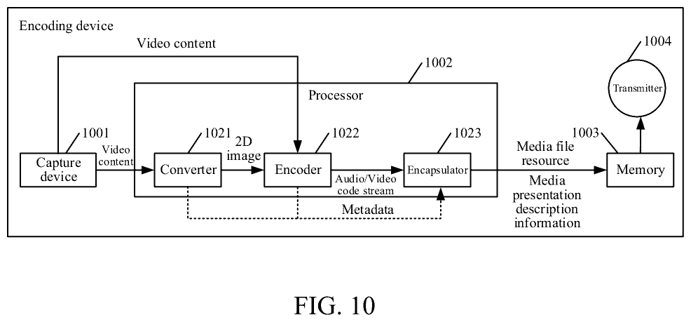

FIG. 10 is a schematic structural diagram of an encoding device according to an embodiment of the present disclosure. The encoding device may be a computer device used by a provider of point cloud media, and the computer device may be a terminal (for example, a PC or an intelligent mobile device (for example, a smartphone)) or a server. As shown in FIG. 10, the encoding device includes a capture device 1001, a processor 1002, a memory 1003, and a transmitter 1004.

The capture device 1001 is configured to collect sound-visual scenes of the real world to obtain original data of point cloud media (including audio content and video content that are synchronized in terms of time and space). The capture device 1001 may include but is not limited to: an audio device, a camera device, and a sensor device. The audio device may include an audio sensor, a microphone, or the like. The camera device may include an ordinary camera, a stereo camera, a light field camera, or the like. The sensor device may include a laser device, a radar device, or the like.

The processor 1002 (or referred to as a CPU) is a processing core of the encoding device, and the processor 1002 is adapted to implementing one or more program instructions, and is specifically adapted to loading and executing the one or more program instructions, to implement the procedure for the point cloud processing method shown in FIG. 4 or FIG. 6.

The memory 1003 is a memory component in the encoding device, and is configured to store a program and a media resource. The memory 1003 herein may include an internal storage medium of the encoding device, and may also include an expanded storage medium supported by the encoding device. The memory may be a high-speed RAM, or may be a non-volatile memory, for example, at least one magnetic disk memory. In some embodiments, the memory 1003 may be at least one memory that is far away from the foregoing processor. The memory provides storage space for storing an operating system of the encoding device. In addition, the storage space is further configured to store a computer program. The computer program includes program instructions, and the program instructions are adapted to being called and executed by the processor to perform the operations of the point cloud processing method. In addition, the memory 1003 may be further configured to store a point cloud media file formed through processing by the processor, where the point cloud media file includes a media file resource and media presentation description information.

The transmitter 1004 is configured to implement transmission interaction between the encoding device and another device, and is specifically configured to implement point cloud media transmission between the encoding device and a content playback device. That is, the encoding device transmits a related media resource of point cloud media to the content playback device through the transmitter 1004.

Refer to FIG. 10 again. The processor 1002 may include a converter 1021, an encoder 1022, and an encapsulator 1023.

The converter 1021 is configured to perform a series of conversion processing on captured video content, to convert the video content into content subject to video coding of the point cloud media. The conversion processing may include: splicing and projection. In some embodiments, the conversion processing also includes region encapsulation. The converter 1021 may convert captured 3D video content into a 2D image, and provide the 2D image to the encoder for video encoding.

The encoder 1022 is configured to perform audio encoding on captured audio content to form an audio code stream of the point cloud media, and is further configured to perform video encoding on the 2D image obtained by the converter 1021 through conversion, to obtain a video code stream.

The encapsulator 1023 is configured to: encapsulate the audio code stream and the video code stream in a file container based on a file format (for example, ISOBMFF) of the point cloud media to form the media file resource of the point cloud media, where the media file resource may be a media file or a media fragment for forming the media file of the point cloud media; and record metadata of the media file resource of the point cloud media by using the media presentation description information based on a file format requirement of the point cloud media. An encapsulated file that is of the point cloud media and that is obtained by the encapsulator through processing is stored in the memory, and is provided to the content playback device for presentation of the point cloud media as required.

The processor 1002 (specifically, each component included in the processor) calls one or more instructions in the memory to perform the operations of the point cloud processing method shown in FIG. 4 or FIG. 6. Specifically, the memory 1003 stores one or more first instructions, and the one or more first instructions are adapted to being loaded by the processor 1002 to perform the following operations:
obtaining to-be-encoded point cloud data;
grouping points in the point cloud data to obtain group information of the point cloud data, the group information indicating an association relationship, related to encoding and decoding, between groups corresponding to the point cloud data;
optimizing a group prediction process based on the association relationship between the groups, to obtain attribute information of the point cloud data; and encoding the attribute information of the point cloud data to obtain code stream data of the point cloud data.

Based on the same inventive concept, the problem-solving principle and beneficial effects of the encoding device provided in this embodiment of the present disclosure are similar to those of the point cloud processing method in the method embodiments of the present disclosure. Refer to the principle and beneficial effects of the implementation of the method. For brevity, details are not described herein again.

An embodiment of the present disclosure further provides a computer-readable storage medium. The computer-readable storage medium stores one or more instructions, and the one or more instructions are adapted to being loaded by a processor to perform the point cloud processing method in the foregoing method embodiments.

An embodiment of the present disclosure further provides a computer program product including instructions, and the computer program product, when running on a computer, causes the computer to perform the point cloud processing method in the foregoing method embodiments.

An embodiment of the present disclosure further provides a computer program product or a computer program, the computer program product or the computer program including computer instructions, and the computer instructions being stored in a computer-readable storage medium. A processor of a computer device reads the computer instructions from the computer-readable storage medium, and executes the computer instructions, to cause the computer device to perform the foregoing point cloud processing method.

As disclosed according to various embodiments of the present disclosure, the code stream data of the point cloud data is obtained; the code stream data is parsed to obtain the group information of the point cloud data; the group prediction process is optimized based on the association relationship between the groups, to obtain the attribute information of the point cloud data; and the point cloud data is presented based on the attribute information of the point cloud data. In another aspect, the to-be-encoded point cloud data is obtained; the points in the point cloud data are grouped to obtain the group information of the point cloud data; the group prediction process is optimized based on the association relationship between the groups to obtain the attribute information of the point cloud data; and the attribute information of the point cloud data is encoded based on the association relationship between the groups to obtain the code stream data of the point cloud data. The group prediction process is optimized based on the association relationship between the groups, so that the prediction result is closer to the actual result, to reduce the amount of data that needs to be encoded or decoded in the encoding or decoding phase, thereby improving the efficiency of encoding or decoding the attribute information of the point cloud.

The operations of the methods in the embodiments of the present disclosure may be adjusted in terms of a sequence, combined, and deleted based on an actual requirement.

The modules in the apparatuses in the embodiments of the present disclosure may be combined, divided, and deleted based on an actual requirement.

A person of ordinary skill in the art can understand that, all or some operations in the methods in the foregoing embodiments may be performed by a program instructing related hardware. The program may be stored in a computer-readable storage medium, and the readable storage medium may include: a flash drive, a ROM, a RAM, a magnetic disk, an optical disc, and the like.

The content disclosed above is merely preferred embodiments of the present disclosure, but is not intended to limit the scope of claims of the present disclosure. A person of ordinary skill in the art can understand all or a part of the procedures for implementing the foregoing embodiments, and any equivalent variation made based on the claims of the present disclosure shall still fall within the scope of the present disclosure.

What is claimed is:

1. A point cloud processing method, performed by a decoding device and comprising:
obtaining code stream data of point cloud data;
parsing the code stream data to obtain group information of the point cloud data, the group information indicating an association relationship, related to encoding and decoding, between groups corresponding to the point cloud data;
optimizing a group prediction process based on the association relationship between the groups, to obtain attribute information of the point cloud data; and
presenting the point cloud data based on the attribute information of the point cloud data.

2. The method according to claim 1, wherein points in the point cloud data are grouped into K groups, and the K groups of points are arranged in decoding order, wherein K is an integer greater than 1; and the optimization of the group prediction process comprises optimizing selection of a prediction candidate point in the group prediction process and further comprises at least one of following:
adding a target prediction point to a (P+1)^{th} group of prediction candidate points, a value of the target prediction point being a weighted average of attribute reconstruction values of first P groups of points, coordinates of the target prediction point being average geometric coordinates of the first P groups of points, and P being a positive integer less than K;
replacing a point in the (P+1)^{th} group of prediction candidate points with the target prediction point; or
using the target prediction point as a prediction candidate point in the (P+1)^{th} group in response to a sum of numbers of points in the first P groups being less than a neighbor quantity threshold.

3. The method according to claim 1, wherein points in the point cloud data are grouped into K groups, wherein K is an integer greater than 1; and the optimization of the group prediction process comprises an optimization of an obtaining of a residual value and further comprises:
obtaining a secondary prediction residual value and a reference residual value that correspond to an i^{th} group, i being a positive integer less than or equal to K; and
calculating a residual value of a point in the i^{th} group based on the secondary prediction residual value and the reference residual value.

4. The method according to claim 3, wherein the K groups of points are arranged in decoding order, and obtaining the secondary prediction residual value and the reference residual value that correspond to the i^{th} group comprises:
parsing the code stream data to obtain the secondary prediction residual value and the reference residual value that correspond to the i^{th} group; or
parsing the code stream data to obtain the secondary prediction residual value corresponding to the i^{th} group, and determining the reference residual value corresponding to the i^{th} group based on a residual value of at least one point in first i groups.

5. The method according to claim 4, wherein determining the reference residual value corresponding to the i^{th} group based on the residual value of at least one point in the first i groups comprises:
determining a residual value of any point in the first i groups as the reference residual value corresponding to the i^{th} group; or
calculating the reference residual value corresponding to the i^{th} group based on residual values of at least two points in the first i groups.

6. The method according to claim 1, wherein points in the point cloud data are grouped into K groups, wherein K is an integer greater than 1; and the optimization comprises an optimization of an obtaining of a transformation coefficient value comprises:
obtaining a secondary transformation coefficient value and a reference transformation coefficient value that correspond to an it group, i being a positive integer less than or equal to K; and
calculating a transformation coefficient value of a point in the i^{th} group based on the secondary transformation coefficient value and the reference transformation coefficient value.

7. The method according to claim 6, wherein the K groups of points are arranged in decoding order, and obtaining the secondary transformation coefficient value and the reference transformation coefficient value that correspond to the i^{th} group comprises:
parsing the code stream data to obtain the secondary transformation coefficient value and the reference transformation coefficient value that correspond to the it group; or
parsing the code stream data to obtain the secondary transformation coefficient value corresponding to the i^{th} group, and determining the reference transformation coefficient value corresponding to the i^{th} group based on a coefficient value of at least one point in first i groups.

8. The method according to claim 7, wherein determining the reference transformation coefficient value corresponding to the i^{th} group based on the coefficient value of the at least one point in the first i groups comprises:
determining a transformation coefficient value of any point in the first i groups as the reference transformation coefficient value of the i^{th} group; or
calculating the reference transformation coefficient value of the i^{th} group based on transformation coefficient values of at least two points in the first i groups.

9. The method according to claim 1, wherein points in the point cloud data are grouped into K groups, a
point in an i^{th} group is associated with R attributes, an attribute of the R attributes corresponds to M transformation coefficients, and the M transformation coefficients corresponding to the attribute of the R attributes comprise one first transformation coefficient and M−1 second transformation coefficients, wherein R is a positive integer, K and M are integers greater than 1, and i is a positive integer less than or equal to K; and the method further comprises:
performing inter-group run-length decoding on the transformation coefficients in the i^{th} group in response to a group run-length corresponding to the i^{th} group being not 0; or decoding the transformation coefficients in the i^{th} group one by one in response to a group run-length corresponding to the i^{th} group being 0; or
directly decoding the first transformation coefficient in the i^{th} group; and performing inter-group run-length decoding on the second transformation coefficient in the i^{th} group in response to a group run-length corresponding to the i^{th} group being not 0; or decoding the second transformation coefficient in the i^{th} group one by one in response to a group run-length corresponding to the i^{th} group being 0.

10. The method according to claim 1, wherein points in the point cloud data are grouped into K groups, an attribute of a j^{th} point in an i^{th} group comprises Q component attributes, and a component attribute of the Q component attributes corresponds to a transformation coefficient, wherein Q is a positive integer, K is an integer greater than 1, i is a positive integer less than or equal to K, and j is a positive integer; and the method further comprises:
directly decoding a non-zero transformation coefficient in the transformation coefficients corresponding to the Q component attributes; or
performing shift-and-residue decoding on a non-zero transformation coefficient in the transformation coefficients corresponding to the Q component attributes.

11. The method according to claim 1, wherein the code stream data comprises S bits of data, wherein S is a positive integer; and the method further comprises:
entropy decoding the S bits of data to obtain the attribute information of the point cloud data; or
performing run-length decoding on the S bits of data to obtain the attribute information of the point cloud data,
the entropy decoding comprising at least one of the following decoding modes: a context model-based decoding mode or a bypass decoding mode; and the attribute information of the point cloud data comprising at least one of the following: a residual value of a point or a transformation coefficient of the point.

12. The method according to claim 11, wherein the entropy decoding comprises the context model-based decoding mode and the bypass decoding mode, wherein the context model-based decoding mode comprises a first context model-based decoding mode and a second context model-based decoding mode; the S bits of data comprise first encoded data and second encoded data; and a process of the entropy decoding the S bits of data comprises:
decoding the first encoded data in the context model-based decoding mode, and decoding the second encoded data in the bypass decoding mode; or
decoding the first encoded data in the first context model-based decoding mode, and decoding the second encoded data in the second context model-based decoding mode.

13. The method according to claim 12, wherein the first encoded data and the second encoded data are obtained by dividing the S bits of data based on at least one preset value.

14. The method according to claim 11, wherein entropy decoding the S bits of data to obtain the attribute information of the point cloud data comprises:
entropy decoding the S bits of data to obtain a binarization result; and
restoring the attribute information of the point cloud data based on the binarization result.

15. The method according to claim 14, wherein restoring the attribute information of the point cloud data based on the binarization result comprises:
restoring a shift-and-residue processing result based on the binarization result; and
calculating the attribute information of the point cloud data based on the shift-and-residue processing result.

16. The method according to claim 1, further comprising:
grouping the points in the point cloud data into the K groups based on a space filling curve, K being the integer greater than 1;
in response to a number of points in the i^{th} group being greater than a first number threshold, grouping, into one group, points that are in the i^{th} group and whose coordinate values in a target direction belong to a numerical interval, the target direction being a direction corresponding to a side with a shortest side length in a three-dimensional frame to which the points in the i^{th} group belong, and i being the positive integer less than or equal to K; and
increasing or decreasing the number of points in the i^{th} group by 1 in response to the number of points in the i^{th} group being odd,
a coordinate arrangement order of the space filling curve being determined based on a three-dimensional frame to which the point cloud data belongs.

17. The method according to claim 16, wherein the K groups of points are arranged in encoding order, and the method further comprises:
merging the i^{th} group and an adjacent group of the i^{th} group to obtain a merged group in response to the number of points in the i^{th} group being less than a second number threshold N, the second number threshold N being less than the first number threshold, and N being a positive integer; and
evenly dividing the merged group to obtain an updated it group and an updated adjacent group of the i^{th} group; or grouping N points in the merged group into an i^{th} group, and grouping points other than the N points in the merged group into an adjacent group of the i^{th} group.

18. A computer device, comprising: a memory and one or more processors,
the memory containing a computer program that, when being executed, causes the one or more processors to perform:
obtaining code stream data of point cloud data;
parsing the code stream data to obtain group information of the point cloud data, the group information indicating an association relationship, related to encoding and decoding, between groups corresponding to the point cloud data;
optimizing a group prediction process based on the association relationship between the groups, to obtain attribute information of the point cloud data; and
presenting the point cloud data based on the attribute information of the point cloud data.

19. The device according to claim 18, wherein the code stream data comprises S bits of data, wherein S is a positive integer, and the one or more processors are further configured to:
entropy decoding the S bits of data to obtain the attribute information of the point cloud data; or
performing run-length decoding on the S bits of data to obtain the attribute information of the point cloud data,
the entropy decoding comprising at least one of following decoding modes: a context model-based decoding mode or a bypass decoding mode; and the attribute information of the point cloud data comprising at least one of a residual value of a point or a transformation coefficient of the point.

20. A non-transitory computer-readable storage medium containing a computer program that, when being executed, causes at least one processor to perform:
obtaining code stream data of point cloud data;
parsing the code stream data to obtain group information of the point cloud data, the group information indicating an association relationship, related to encoding and decoding, between groups corresponding to the point cloud data;
optimizing a group prediction process based on the association relationship between the groups, to obtain attribute information of the point cloud data; and
presenting the point cloud data based on the attribute information of the point cloud data.
